(19) United States
(12) Patent Application Publication
(10) Pub. No.: US 2025/0215159 A1
(43) Pub. Date: Jul. 3, 2025

(54) CONDUCTIVE URETHANE ACRYLATE AND SILICONE HYBRID ELECTRODES AND METHODS OF USING THE SAME

(71) Applicant: Meta Platforms Technologies, LLC, Menlo Park, CA (US)

(72) Inventors: Li Yao, Bothell, WA (US); Fang He, Bothell, WA (US); Robert Cole Bolger-Cruz, Riverside, CA (US); Simon Jacobs, Lucas, TX (US); Kristopher Erickson, Sammamish, WA (US)

(21) Appl. No.: 19/001,222

(22) Filed: Dec. 24, 2024

Related U.S. Application Data
(60) Provisional application No. 63/616,409, filed on Dec. 29, 2023.

(51) Int. Cl. C08G 77/388; C08G 77/20; C08K 3/04; C08K 3/08; C08K 7/06

(52) U.S. Cl. CPC C08G 77/388; C08G 77/20; C08K 3/041; C08K 3/08; C08K 7/06; C08K 2201/001

(57) ABSTRACT

A method of synthesizing a crosslinked polymer electrode is provided. The method includes meltmixing (i) methylvinyl silicone rubber (MVQ) having a vinyl content of between 0.05 percent and 5 percent and (ii) urethane acrylate at a temperature of between 125° C. and 225° C., which forms a solution. Moreover, the MVG to urethane acrylate wt/wt ratio is between 1:10 and 1000:1 at initiation of the meltmixing. The method includes adding a peroxide, at between 0.1 wt % to 5 wt % to the solution, while mixing the solution, which forms the crosslinked polymer electrode in which the MVQ is cross-linked with urethane acrylate. Moreover, the crosslinked polymer electrode has a Young's modulus of between 0.5 MPa and 24 GPa.

### CROSS-REFERENCE TO RELATED APPLICATION

The present Application claims priority to U.S. Provisional Patent Application No. 63,616,409, entitled “Conductive Urethane Acrylate and Silicone Hybrid electrodes and Methods of Using the Same,” filed Dec. 29, 2023, which is hereby incorporated by reference in its entirety for all purposes.

### FIELD OF THE PRESENT DISCLOSURE

The present Application relates to conductive urethane acrylate and silicone hybrid electrodes and methods of using the same or producing the same.

### BACKGROUND

Conventionally, fabrication and utilization of conductive elastomers has been difficult to achieve. For instance, such conductive elastomers typically have a high bulk modulus (e.g., greater than 10 megapascals (MPa)), which yields relatively rigid materials that are unsuitable for activities that require the material to deform upon impact, strain, or the like. Moreover, typical conductive polymers that do have sufficient modulus have a low bonding strength and have tensile strengths below that of the bonding strength, which prevents the conductive polymer from coupling with a variety of materials that are found in everyday life, such as plastic, fabric, metal, or the like including printed circuit boards. For instance, silicone has a low surface energy, which makes the silicone difficult to bond to most substrates. Additionally, typical conductive polymers lack suitable skin contact impedance, which generates a large noise-to-signal ratio when utilized to facilitate electronic communication through the material the conductive polymer is coupled to, such as when utilized for wearable devices that facilitate computational analysis.

### SUMMARY

Based on the above background there is a need in the art for suitable substitutes for rigid conductive polymers that can be used in various real-world applications. The present disclosure addresses this need in the art with peroxide cured conductive urethane acrylate and silicone hybrid electrodes that can be used in wearable computational applications.

In some embodiments, the present disclosure is directed to systems, methods, and devices that provide an electrode that is based on a hybrid conductive elastomer in the form of a crosslinked polymer electrode. The crosslinked polymer electrode includes both urethane acrylate and silicone that are linearly cross-linked. As such, the urethane acrylate and the silicone interact synergistically to increase both the softness (e.g., modulus) and bonding strength of the crosslinked polymer electrode to one or more substrate materials, such as plastic substrates, metal substrates, elastomeric substrates, and the like. For instance, by including the urethane acrylate, the crosslinked polymer electrode has improved bonding strength and durability when bonding to the one or more substrates, whereas the silicone provides improved elasticity and viscosity. Moreover, the crosslinked polymer electrode is cured using peroxide, which acts as a catalyst when meltmixing the urethane acrylate and silicone to produce the crosslinked polymer electrode. Furthermore, the crosslinked polymer electrode has a high internal strength, which provides improved toughness and resistance to abrasions, in that the crosslinked polymer electrode has a bonding strength that is greater than its tensile strength yet does not exceed the tensile strength so far as to destabilize the crosslinked polymer electrode. Additionally, in some embodiments, the crosslinked polymer electrode includes one or more fillers, such as one or more carbonaceous fillers and/or one or more metallic fillers, which allows for the crosslinked polymer electrode to conduct electricity and facilitate electronic communication through a circuit.

One aspect of the present disclosure provides a method of synthesizing a crosslinked polymer. The method includes meltmixing (i) methylvinyl silicone rubber (MVQ) having a vinyl content of between 0.05 percent and 5 percent and (ii) urethane acrylate at a temperature of between 125° C. and 225° C., which forms a solution. Moreover, the MVG to urethane acrylate wt/wt ratio is between 1:10 and 1000:1 at initiation of the meltmixing. Moreover, the method includes adding a peroxide, at between 0.1 wt % to 5 wt % to the solution, while mixing the solution. From this adding and mixing, the method forms the crosslinked polymer in which the MVQ is cross-linked with urethane acrylate. The resultant crosslinked polymer can be used in several practical applications, such as an electrode in a circuit or other electronic device, and has a Young's modulus of between 0.5 megapascals (MPa) and 24 gigapascals (GPa). In some embodiments, the Young's modulus of the resultant crosslinked polymer is between 2 MPa and 10 MPa.

In some embodiments, the urethane acrylate has an average molecular weight of between 1,000 g/mole and 5,000 g/mole.

In some embodiments, the peroxide is 2,5-di(tertbutylperoxy)-2,5-mercapropinoate (DBPH).

In some embodiments, the MVQ has an average molecular weight of between 500 g/mole and 900,000 g/mole.

In some embodiments, the method further includes adding a filler to the solution during the adding step. In some embodiments, the method further includes coupling the filler to the MVQ and/or the urethane acrylate prior to the meltmixing.

In some embodiments, the filler is carbonaceous.

In some embodiments, the carbonaceous filler includes one or more carbon nanotubes, one or more carbon nanofibers, one or more carbon blacks, graphene, or a combination thereof.

In some embodiments, the filler includes a metal.

In some embodiments, the metal is gold, silver, tungsten, or a combination thereof.

In some embodiments, the metal filler is in the form of one or more gold nanoparticles, gold nanowire, gold flake, one or more silver nanoparticles, silver nanowire, silver flake, or a combination thereof.

In some embodiments, the filler is coupled with the MVQ and/or the urethane

acrylate prior to the meltmixing.

In some embodiments, the filler is covalently bonded with the MVQ and/or the urethane acrylate prior to the meltmixing.

In some embodiments, the method further includes introducing an additive polymer having a conductance of between 0.00001 Siemens per centimeter (S/cm) and 100,000 S/cm to the solution during the adding. In some embodiments, the conductive of the additive polymer is between 0.001 S/cm and 1,000 S/cm.

In some embodiments, the method further includes introducing one or more hydrophilic materials and/or one or more hygroscopic materials to the solution during the adding.

In some embodiments, the method further includes introducing one or more foaming agents to the solution during the adding.

In some embodiments, a surface roughness average (Ra) of a first surface of the crosslinked polymer is between 0.1 Ra and 3 Ra. In some embodiments, the surface roughness average is between 0.2 Ra and 1 Ra.

In some embodiments, a resistivity of the crosslinked polymer is between 0.01 Ohms centimeter (Ω-cm) and 10 Ω-cm. In some embodiments, the resistivity of the crosslinked polymer is between 0.1 Ω-cm and 2 Ω-cm.

In some embodiments, a Shore A hardness of the crosslinked polymer is between 20 and 95.

In some embodiments, an abrasion resistance maximum loss of the crosslinked polymer is between 0 milligrams (mg) and 65 mg.

In some embodiments, the crosslinked polymer has a tensile strength between 2 Megapascals (MPa) and 20 GPa. In some embodiments, the tensile strength of the crosslinked polymer is between 4 MPa and 20 MPa.

In some embodiments, the compressibility of the crosslinked polymer is between 20% and 90%. In some embodiments, the compressibility of the crosslinked polymer is between 40% and 80%.

In some embodiments, the maximum strain along a first axis of the crosslinked polymer is between 20% and 1,000% elongation. In some embodiments, the maximum strain along the first axis is between 20% and 30% elongation.

Another aspect of the present disclosure is directed to providing an electronic device. The electronic device includes a first circuit component. Moreover, the electronic device includes a crosslinked polymer electrode in electronic communication with the first circuit component. The crosslinked polymer electrode includes methylvinyl silicone rubber (MVQ) cross-linked with urethane acrylate where the MVG to urethane acrylate wt/wt ratio is between 1:10 and 1000:1 and the Young's modulus of the electrode is between 0.5 MPa and 24 GPa. In some embodiments, the Young's modulus of the electrode is between 2 MPa and 10 MPa.

In some embodiments, the electronic device further includes a substrate. Moreover, the crosslinked polymer electrode is disposed as a layer on the substrate and in electrical communication with the first circuit component through the substrate. Additionally, the substrate includes a metal, a plastic, an elastomer, or a combination thereof.

In some embodiments, the layer has a thickness between 15 microns (μm) and 5,000 μm.

In some embodiments, the electronic device further includes a substrate. In some such embodiments, the crosslinked polymer electrode includes one or more folded layers formed on the substrate and in electrical communication with the first circuit component through the substrate. Furthermore, the substrate includes a metal material, a plastic material, an elastomer material, or a combination thereof.

In some embodiments, the one or more folds includes one or more alternating folds.

In some embodiments, a surface roughness average (Ra) of a first surface of the crosslinked polymer electrode is between 0.1 Ra and 3 Ra.

In some embodiments, a resistivity of the crosslinked polymer electrode is between 0.01 Ohms centimeter (Ω-cm) and 10 Ω-cm. In some embodiments, the resistivity of the crosslinked polymer electrode is between 2 Ω-cm and 10 Ω-cm.

In some embodiments, a Shore A hardness of the crosslinked polymer electrode is between 20 and 95.

In some embodiments, an abrasion resistance maximum loss of the crosslinked polymer electrode is between 0 milligrams (mg) and 65 mg.

In some embodiments, the crosslinked polymer electrode has a tensile strength that is between 2 MPa and 20 GPa.

In some embodiments, a maximum strain along a first axis of the crosslinked polymer electrode is between 20% and 1,000% elongation.

In some embodiments, the compressibility of the crosslinked polymer electrode is between 20% and 90%. In some embodiments, the compressibility of the crosslinked polymer electrode is between 40% and 80%.

Yet another aspect of the present disclosure is directed to a crosslinked polymer composition. In some embodiments, the crosslinked polymer composition includes a matrix that includes silicone cross-linkeded with urethane acrylate. In some embodiments, the crosslinked polymer composition includes a filler that is disposed within the matrix. In some embodiments, the crosslinked polymer composition has a Young's modulus of between 0.5 megapascals (MPa) and 24 GPa. In some embodiments, the crosslinked polymer composition has a tensile strength between 2 megapascals (MPa) and 20 GPa. In some embodiments, the compressibility of the crosslinked polymer composition is between 20% and 90%. In some embodiments, the resistivity of the crosslinked polymer composition is between 0.01 Ohms centimeter (Ω-cm) and 10 Ω-cm. In some embodiments, the Shore A hardness of the crosslinked polymer composition is between 20 and 95.

### BRIEF DESCRIPTION OF THE DRAWINGS

FIG. 1 illustrates an exemplary system topology including an electronic device, in accordance with some embodiments of the present disclosure;

FIG. 2 illustrates an exemplary diagram of a crosslinked polymer electrode, in accordance with some embodiments of the present disclosure;

FIG. 3 illustrates an exemplary electronic device that includes a substrate layer and a crosslinked polymer electrode, in accordance with some embodiments of the present disclosure;

FIG. 4 illustrates another exemplary electronic device that includes a substrate layer and a crosslinked polymer electrode, in accordance with some embodiments of the present disclosure;

FIGS. 5A, 5B, and 5C collectively provide a flowchart illustrating a method for synthesizing a crosslinked polymer electrode, in accordance with some embodiments of the present disclosure;

FIG. 6 illustrates a chart depicting a comparison of material parameters for a crosslinked polymer electrode, in accordance with some embodiments of the present disclosure;

FIG. 7 illustrates another chart depicting a comparison of material parameters for a crosslinked polymer electrode, in accordance with some embodiments of the present disclosure;

FIG. 8 illustrates another exemplary electronic device that includes a substrate layer and a crosslinked polymer electrode, in accordance with some embodiments of the present disclosure;

FIG. 9 illustrates yet another exemplary electronic device that includes a substrate layer and a crosslinked polymer electrode, in accordance with some embodiments of the present disclosure;

FIG. 10 illustrates yet another exemplary electronic device that includes a substrate layer and a crosslinked polymer electrode, in accordance with some embodiments of the present disclosure;

FIG. 11 illustrates various logic functions that are implemented by an electronic device in some embodiments of the present disclosure.

### DETAILED DESCRIPTION OF THE INVENTION

The present disclosure provides systems, methods, and devices for synthesizing a crosslinked polymer. In some embodiments, synthesizing the crosslinked polymer includes meltmixing (i) methylvinyl silicone rubber (MVQ) and (ii) urethane acrylate, which forms a solution. In some such embodiments, the MVQ has a vinyl content of between 0.05 percent and 5 percent. Moreover, in some such embodiments, the urethane acrylate is at a temperature between 125° C. and 225° C. Moreover, the MVG to urethane acrylate wt/wt ratio is between 1:10 and 1000:1 at initiation of the meltmixing. In some embodiments, synthesizing the crosslinked polymer includes adding a peroxide, at between 0.1 wt % to 5 wt % to the solution, while mixing the solution, which forms the crosslinked polymer in which the MVQ is cross-linked with urethane acrylate. Furthermore, the crosslinked polymer has a Young's modulus of between 0.5 megapascals (MPa) and 24 gigapascals (GPa). In some embodiments, the Young's modulus of the crosslinked polymer is between 2 MPa and 10 MPa. Accordingly, the crosslinked polymer of the present disclosure provides a flexible yet durable component for incorporation into everyday electronics, such as wearable devices that conduct computational analysis. As such, in some embodiments, the crosslinked polymer is synthesized by taking advantage of three types of interactions: (i) covalent bonding between the polymer chains through the radicalization of the acrylate; (ii) hydrogen bonding of the urethane to the MVQ; and (iii) intrachain entanglement within the polymer chains, which collectively provides a durable, flexible, and conductive material that can be used in electronic applications, such as an electrode.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

Plural instances may be provided for components, operations or structures described herein as a single instance. Finally, boundaries between various components, operations, and data stores are somewhat arbitrary, and particular operations are illustrated in the context of specific illustrative configurations. Other forms of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first layer could be termed a second layer, and, similarly, a second layer could be termed a first layer, without departing from the scope of the present disclosure. The first layer and the layer are both layers, but they are not the same layer.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description included example systems, methods, techniques, instruction sequences, and computing machine program products that embody illustrative implementations. For purposes of explanation, numerous specific details are set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions below are not intended to be exhaustive or to limit the implementations to the precise forms disclosed. Many modifications and variations are possible in view of the above teachings. The implementations are chosen and described in order to best explain the principles and their practical applications, to thereby enable others skilled in the art to best utilize the implementations and various implementations with various modifications as are suited to the particular use contemplated.

In the interest of clarity, not all of the routine features of the implementations described herein are shown and described. It will be appreciated that, in the development of any such actual implementation, numerous implementation-specific decisions are made in order to achieve the designer's specific goals, such as compliance with use case constraints, and that these specific goals will vary from one implementation to another and from one designer to another. Moreover, it will be appreciated that such a design effort might be complex and time-consuming, but nevertheless be a routine undertaking of engineering for those of ordering skill in the art having the benefit of the present disclosure.

For convenience in explanation and accurate definition in the appended claims, the terms “upper,” “lower,” “up,” “down,” “upwards,” “downwards,” “laterally,” “longitudinally,” “inner,” “outer,” “inside,” “outside,” “inwardly,” “outwardly,” “interior,” “exterior,” “front,” “rear,” “back,” “forwards,” and “backwards” are used to describe features of the exemplary embodiments with reference to the positions of such features as displayed in the figures.

Furthermore, when a reference number is given an “i^{th}” denotation, the reference number refers to a generic component, set, or embodiment. For instance, a circuit component “circuit component i” refers to the i^{th} circuit component in a plurality of circuit components (e.g., a circuit component 800-i in a plurality of circuit components 800).

As used herein, the term “deformable substrate” refers to a substrate or a portion of it (e.g., a layer) capable of altering its shape subject to pressure or stress.

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.

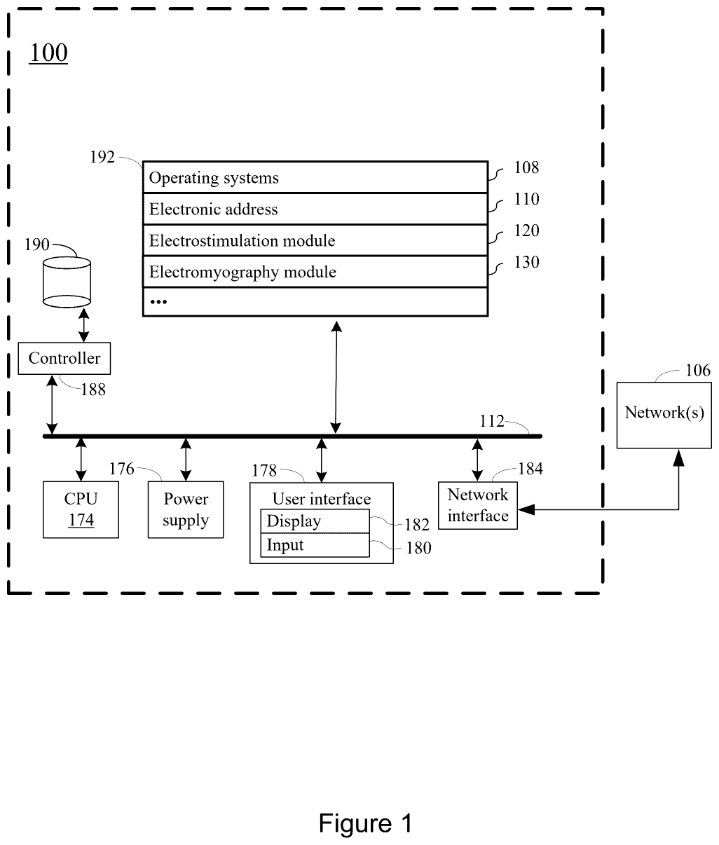

In the present disclosure, unless expressly stated otherwise, descriptions of devices and systems will include implementations of one or more electronic devices. For instance, and for purposes of illustration in FIG. 1, an electronic device 100 is represented as single device that includes all the functionality of the electronic device 100. However, the present disclosure is not limited thereto. For instance, the functionality of the electronic device 100 may be spread across any number of networked computers and/or reside on each of several networked computers and/or be hosted on one or more virtual machines and/or containers at a remote location accessible across a communications network (e.g., networks 106). One skilled in the art of the present disclosure will appreciate that a wide array of different computer topologies is possible for the electronic device 100, and other devices and systems of the preset disclosure, and that all such topologies are within the scope of the present disclosure. As such, the exemplary topology shown in FIG. 1 merely serves to describe the features of an embodiment of the present disclosure in a manner that will be readily understood to one skilled in the art.

Referring to Figure, a system for synthesizing a crosslinked polymer electrode is provided. More specifically, FIG. 1 depicts a block diagram of an electronic device (e.g., electronic device 100) according to some embodiments of the present disclosure.

In some embodiments, the communication networks 106 optionally includes the Internet, one or more local area networks (LANs), one or more wide area networks (WANs), other types of networks, or a combination of such networks.

Examples of communication networks 106 include the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11 and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

In various embodiments, the electronic device 100 includes one or more processing units (CPUs) 174, a network or other communications interface 184, and a memory 192.

The memory 192 includes high-speed random access memory, such as DRAM, SRAM, DDR RAM, or other random access solid state memory devices, and optionally also includes non-volatile memory, such as one or more magnetic disk storage devices, optical disk storage devices, flash memory devices, or other non-volatile solid state storage devices. The memory 192 may optionally include one or more storage devices remotely located from the CPU(s) 174. The memory 192, or alternatively the non-volatile memory device(s) within memory 192, includes a non-transitory computer readable storage medium. Access to memory 192 by other components of the electronic device 100, such as the CPU(s) 174, is, optionally, controlled by a controller. In some embodiments, the memory 192 can include mass storage that is remotely located with respect to the CPU(s) 174. In other words, some data stored in the memory 192 may in fact be hosted on devices that are external to the electronic device 100, but that can be electronically accessed by the electronic device 100 over an Internet, intranet, or other form of communication network 106 or electronic cable using communication interface 184.

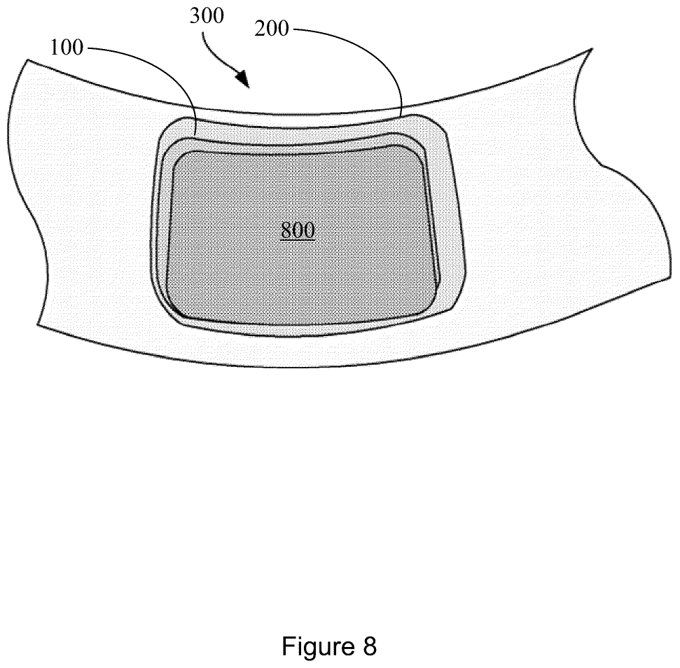

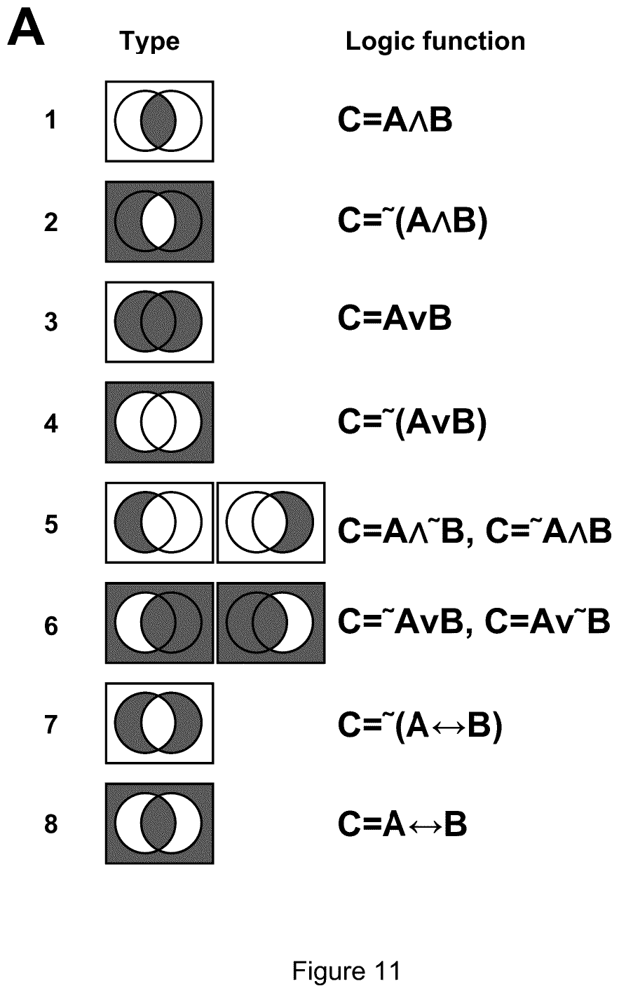

In some embodiments, the memory 192 of the electronic device 100 stores:
an optional operating system 108 (e.g., ANDROID, IOS, DARWIN, RTXC, LINUX, UNIX, OS X, WINDOWS, or an embedded operating system such as VxWorks) that includes procedures for handling various basic system services;
an electronic address 110 associated with the electronic device 100 that identifies the electronic device 100;
optionally, an electrostimulation module that stores one or more logic functions (e.g., one or more logic functions of FIG. 11) for generating and/or communicating one or more electronic signals to one or more circuit components (e.g., circuit component 800 of FIG. 8,, etc.); and
optionally, an electromyography module that stores one or more logic functions (e.g., one or more logic functions of FIG. 11) for evaluation one or more electronic signals received from the one or more circuit components (e.g., circuit component 800 of FIG. 8, etc.).

In some embodiments, an electronic address 110 is associated with the electronic device 100. The electronic address 110 is utilized to identify the electronic device 100 at least uniquely from other devices and components, such as though communicated with through the communications network 106.

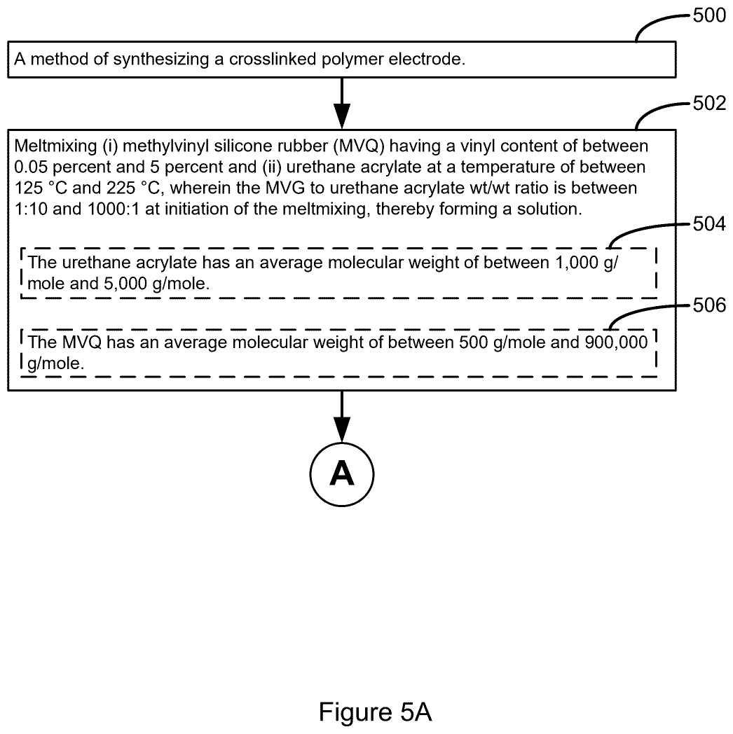

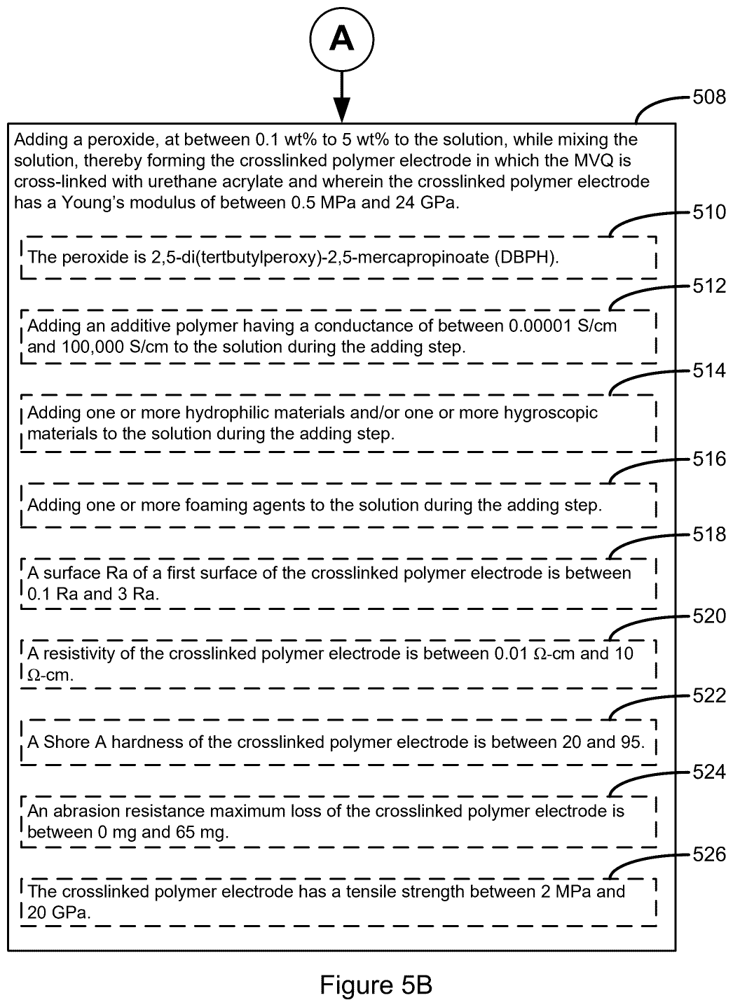

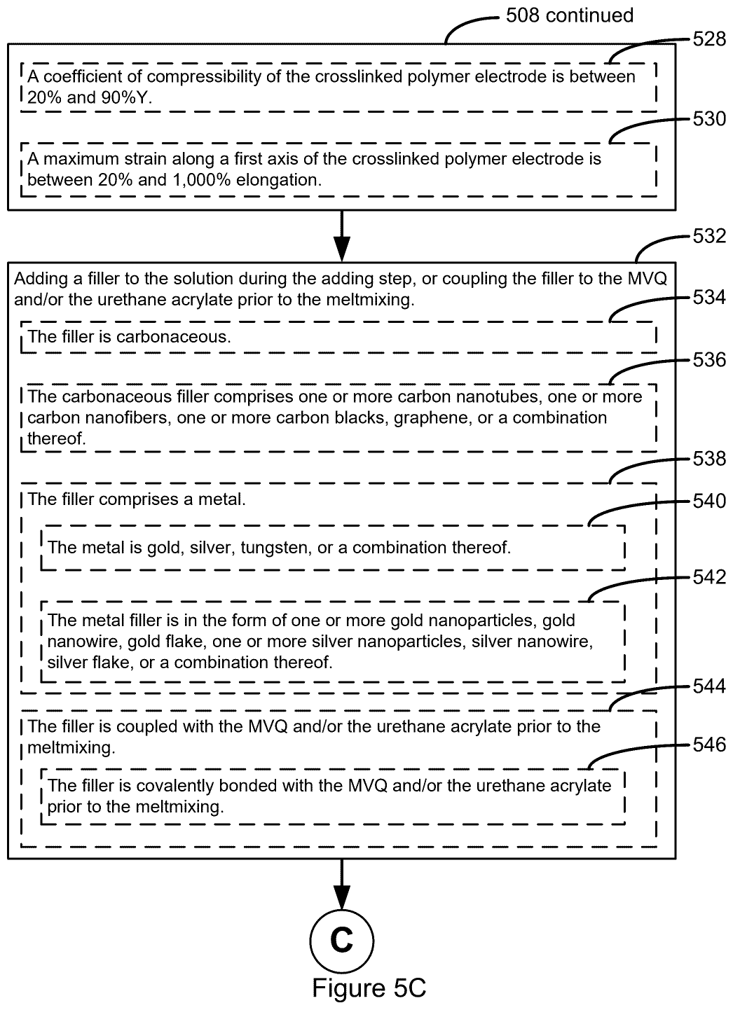

Each of the above identified modules and applications correspond to a set of executable instructions for performing one or more functions described above and the methods described in the present disclosure (e.g., the computer-implemented methods and other information processing methods described herein; method 500 of FIG. 5; etc.). These modules (e.g., sets of instructions) need not be implemented as separate software programs, procedures or modules, and thus various subsets of these modules are, optionally, combined or otherwise re-arranged in various embodiments of the present disclosure. In some embodiments, the memory 192 optionally stores a subset of the modules and data structures identified above. Furthermore, in some embodiments, the memory 192 stores additional modules and data structures not described above.

It should be appreciated that the electronic device 100 of FIG. 1 is only one example of an electronic device 100, and that electronic device 100 optionally has more or fewer components than shown, optionally combines two or more components, or optionally has a different configuration or arrangement of the components. The various components shown in FIG. 1 are implemented in hardware, software, firmware, or a combination thereof, including one or more signal processing and/or application specific integrated circuits.

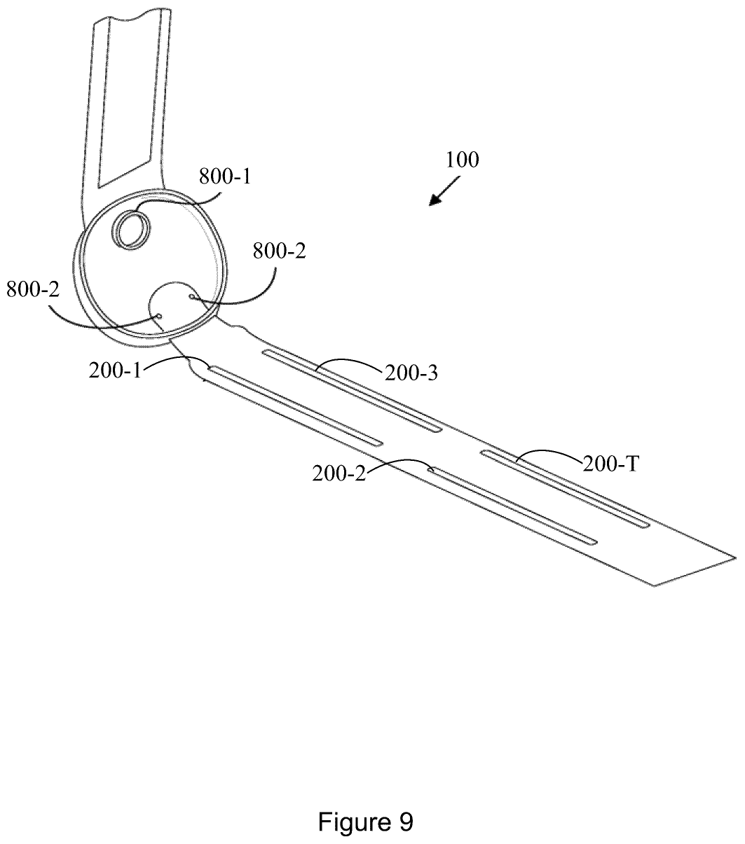

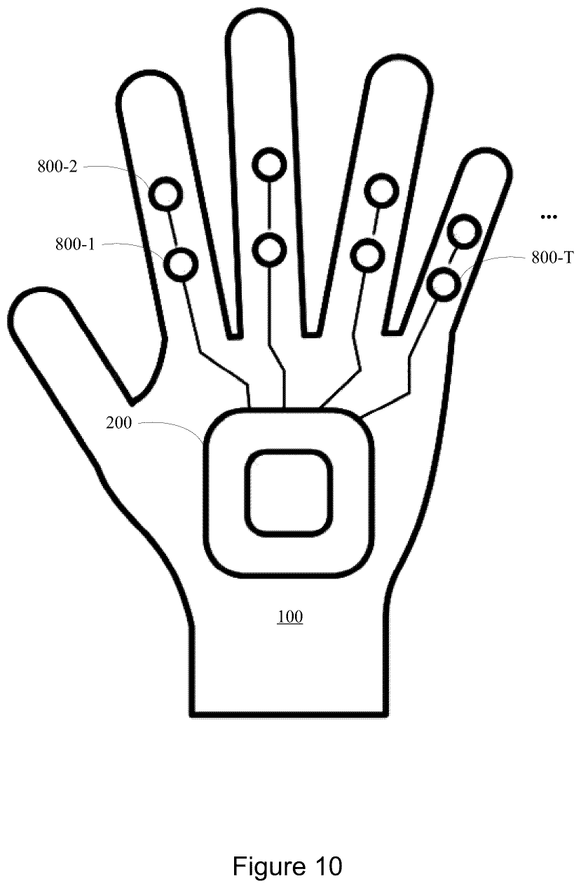

For instance, referring briefly to FIG. 9, in some embodiments, the electronic device 100 is a garment that is worn by a subject, such as around a wrist, a hand, a finger, or a combination thereof of the subject. However, the present disclosure is not limited thereto. For instance, in some embodiments, the electronic device 100 is a garment accessory worn but the subject, such as a pair of glasses (e.g., smart glasses) or a wristwatch (e.g., smart watch) worn by the subject.

In some embodiments, the electronic device 100 includes a circuit that further includes two or more circuit components 800. For instance, in some embodiments, a circuit component 800 of a circuit of the electronic device 100 includes a terminal, an energy source (e.g., power supply 176 of FIG. 1), an interconnect (e.g., a line interconnect, such as a wire), a load (e.g., a device such as display 182 of FIG. 1, a sensor, etc.), a controller (e.g., switch, CPU 174 of FIG. 1), or a combination thereof. As a non-limiting example, in some embodiments, the circuit component 800 includes a terminal, resistor, a transistor, a capacitor, an inductor, a transformer, a diode, a sensor, or a combination thereof.

In some embodiments, the electronic device 100 includes between 2 and 10 million circuit components 800, between 2 and 1 million circuit components 800, between 2 and 100,000 circuit components 800, between 2 and 10,000 circuit components 800, between 2 and 1,000 circuit components 800, between 2 and 100 circuit components 800, between 2 and 10 circuit components 800, between 5 and 10 million circuit components 800, between 5 and 1 million circuit components 800, between 5 and 100,000 circuit components 800, between 5 and 10,000 circuit components 800, between 5 and 1,000 circuit components 800, between 5 and 100 circuit components 800, between 5 and 10 circuit components 800, between 10 and 10 million circuit components 800 (e.g., first circuit component 800-1, second circuit component 800-10, . . . , circuit component T 200-T), between 10 and 1 million circuit components 800, between 10 and 100,000 circuit components 800, between 10 and 10,000 circuit components 800, between 10 and 1,000 circuit components 800, between 10 and 100 circuit components 800, between 500 and 10 million circuit components 800, between 500 and 1 million circuit components 800, between 500 and 100,000 circuit components 800, between 500 and 10,000 circuit components 800, between 500 and 1,000 circuit components 800, between 5,000 and 10 million circuit components 800 (e.g., first circuit component 800-1, second circuit component 800-2, . . . , circuit component T 200-N, in which T is less than or equal to 10 million), between 5,000 and 1 million circuit components 800, between 5,000 and 100,000 circuit components 800, or between 5,000 and 10,000 circuit components 800.

In some embodiments, the electronic device 100 includes at least 2 circuit components 800, at least 3 circuit components 800, at least 5 circuit components 800, at least 10 circuit components 800, at least 50 circuit components 800, at least 100 circuit components 800, at least 500 circuit components 800, at least 1,000 circuit components 800, at least 5,000 circuit components 800, at least 10,000 circuit components 800, at least 25,000 circuit components 800, at least 40,000 circuit components 800, at least 100,000 circuit components 800, at least 250,000 circuit components 800, at least 500,000 circuit components 800, at least 1 million circuit components 800, at least 5 million circuit components 800, or at least 10 million circuit components 800. In some embodiments, the electronic device 100 includes at most 2 circuit components 800, at most 3 circuit components 800, at most 5 circuit components 800, at most 10 circuit components 800, at most 50 circuit components 800, at most 100 circuit components 800, at most 500 circuit components 800, at most 1,000 circuit components 800, at most 5,000 circuit components 800, at most 10,000 circuit components 800, at most 25,000 circuit components 800, at most 40,000 circuit components 800, at most 100,000 circuit components 800, at most 250,000 circuit components 800, at most 500,000 circuit components 800, at most 1 million circuit components 800, at most 5 million circuit components 800, or at most 10 million circuit components 800.

Accordingly, the electronic device 100 of the present disclosure is capable of incorporating a variety of numbers of circuit components 800, which allows providing electronic devices 100 of high complexity, such as wearable garment electronic devices 100.

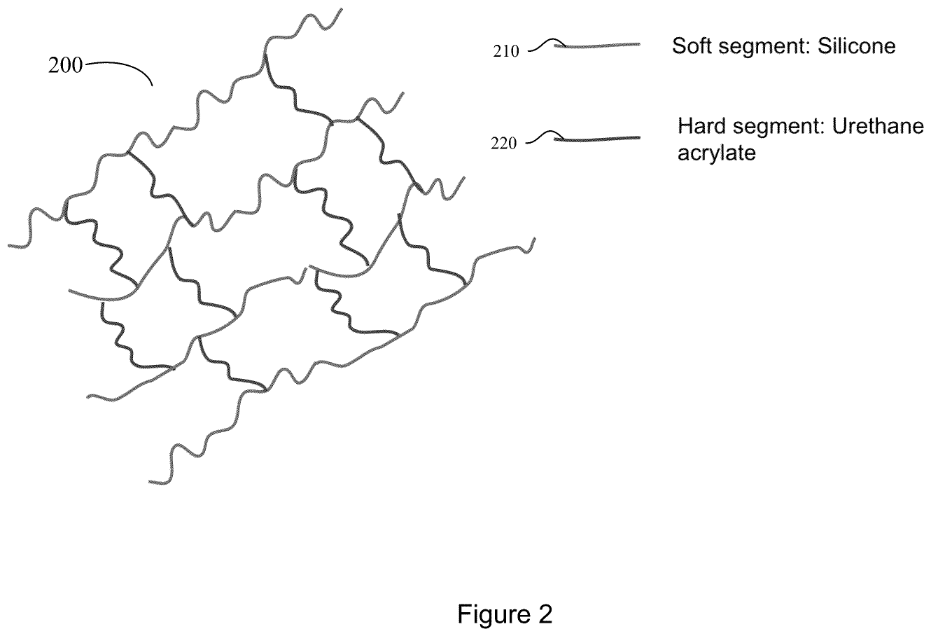

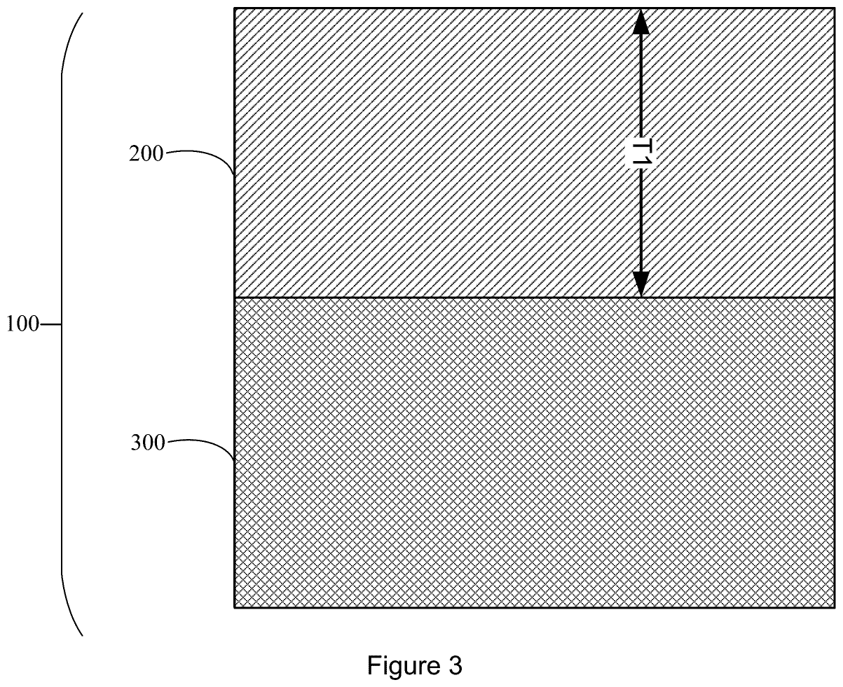

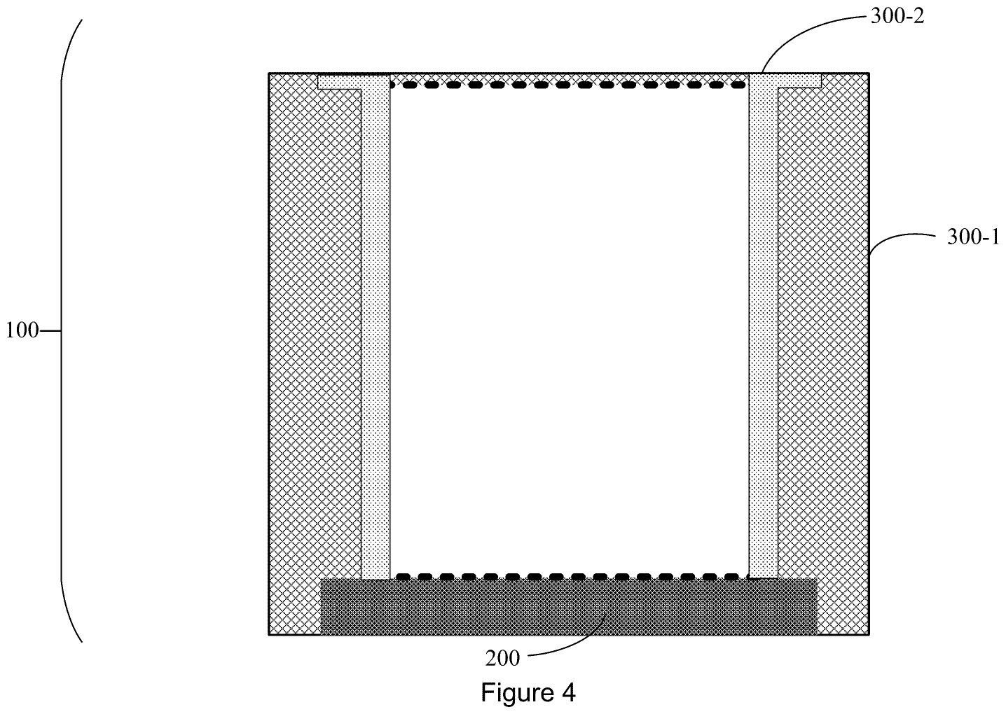

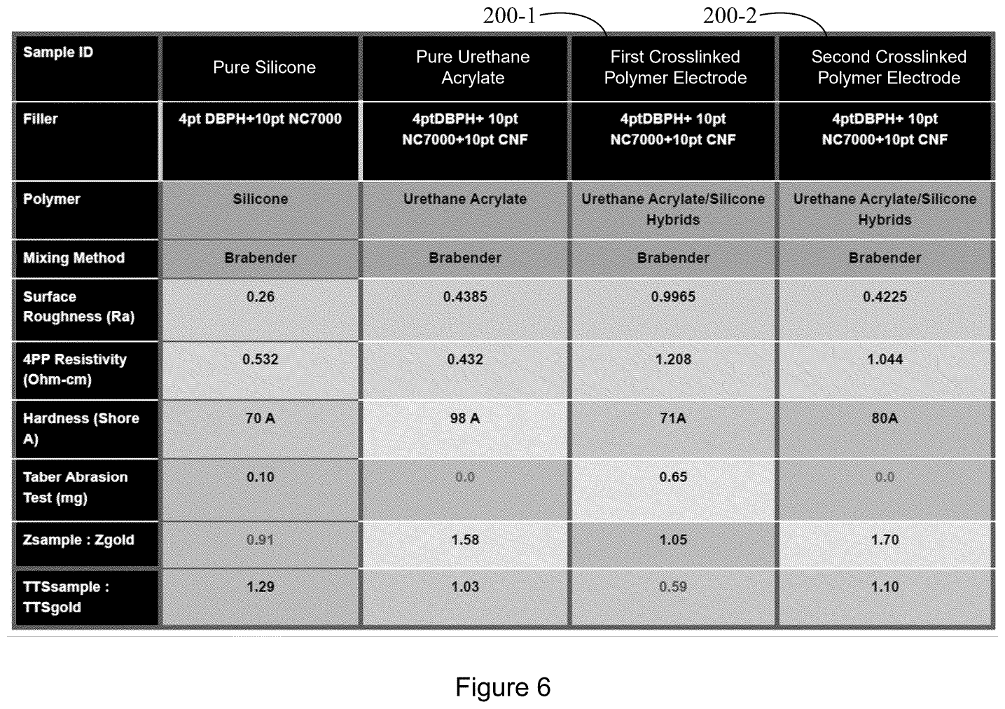

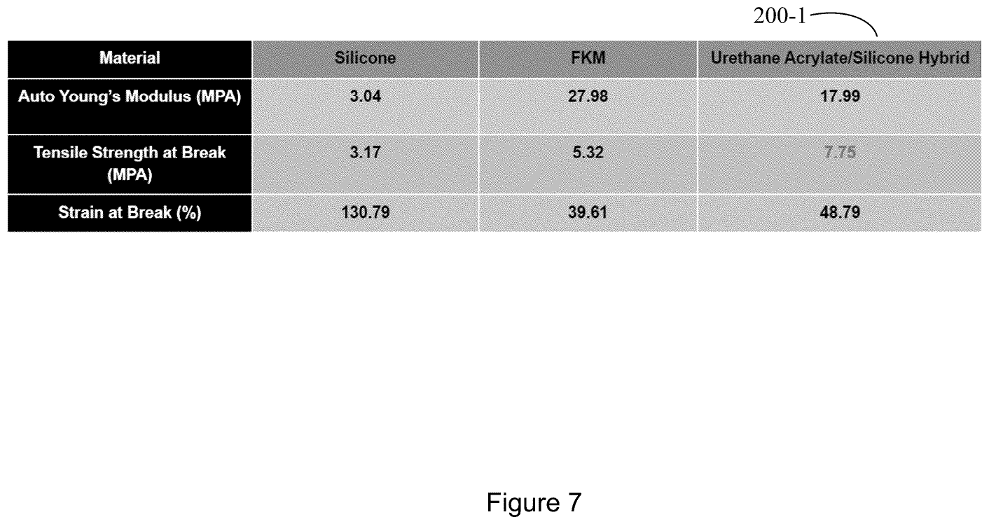

The electronic device 100 includes a crosslinked polymer electrode (e.g., crosslinked polymer electrode 200 of FIG. 2, crosslinked polymer electrode 200 of FIG. 3, crosslinked polymer electrode 200 of FIG. 4, crosslinked polymer electrode 200 of method 500 of FIGS. 5A-5C, crosslinked polymer electrode 200-1 of FIG. 6, crosslinked polymer electrode 200-2 of FIG. 6, crosslinked polymer electrode 200 of FIG. 7, crosslinked polymer electrode 200 of FIG. 8, crosslinked polymer electrode 200 of FIG. 9, etc.), in electronic communication with the first circuit component 800.

In some embodiments, the crosslinked polymer electrode 200 includes methylvinyl silicone rubber (MVQ) (e.g., MVQ 210 of FIG. 2) that is cross-linked with urethane acrylate (e.g., urethane acrylate 220 of FIG. 2). Accordingly, the MVQ 210 provides a soft component and the urethane acrylate 220 provides a hard component to the crosslinked polymer electrode 200. Moreover, in some embodiments, the MVQ 210 to urethane acrylate 220 weight percent ratio (wt/wt) is between 1:10 and 1000:1. Furthermore, in some embodiments, the Young's modulus of the crosslinked polymer electrode is between 0.5 MPa and 24 GPa, between 2 MPa and 10 MPa, or between 10 GPa and 24 GPa. Additional details and information regarding the crosslinked polymer electrode are discussed supra, for example, at FIGS. 5A through 5C.

In some embodiments, the electronic device further 100 includes a substrate (e.g., substrate 300 of FIG. 3, substrate 300 of FIG. 4). In some embodiments, the substrate 300 is rigid, such as fiberglass, plastic, an epoxy resin material, or the like. In some embodiments, the substrate 300 is flexible or deformable, such as a fabric material or elastomer material. As a non-limiting example, in some embodiments, the substrate 300 includes a metal material (e.g., gold, copper, silver, nickel, iron, aluminum, or a combination thereof), a plastic material, an elastomer material (e.g., rubber, silicon, etc.), or a combination thereof.

Moreover, in some embodiments, the crosslinked polymer electrode 200 is disposed as a layer on the substrate 300. Accordingly, the crosslinked polymer electrode 200 is placed in electrical communication with the first circuit component 800-1 through the substrate 300.

In some embodiments, the layer of the crosslinked polymer electrode 200 has a thickness (e.g., thickness T1 of FIG. 3) that is between 15 microns (μm) and 5,000 μm, between 15 and 2,500 μm, between 15 and 1,500 μm, between 15 and 750 μm, between 15 and 250 μm, between 15 and 100 μm, between 15 and 50 μm, between 100 μm and 5,000 μm, between 100 μm and 2,500 μm, between 100 μm and 1,500 μm, between 100 μm and 750 μm, between 100 μm and 250 μm, between 500 μm and 5,000 μm, between 500 μm and 2,500 μm, between 500 μm and 1,500 μm, between 500 μm and 750 μm, between 500 μm and 2,0 μm, between 500 μm and 100 μm, between 500 μm and 50 μm, between 1,300 μm and 5,000 μm, between 1,300 μm and 2,500 μm, between 1,300 μm and 1,500 μm, between 2,400 μm and 5,000 μm, between 2,400 μm and 2,500 μm, or between 3,750 μm and 5,000 μm.

In some embodiments, the thickness of the layer of the crosslinked polymer electrode 200 is at least 15 μm, at least 25 μm, at least 50 μm, at least 100 μm, at least 175 μm, at least 250 μm, at least 750 μm, at least 1,000 μm, at least 1,250 μm, at least 1,500 μm, at least 1,750 μm, at least 2,000 μm, at least 2,250 μm, at least 2,500 μm, at least 2,750 μm, at least 3,000 μm, at least 3,250 μm, at least 3,500 μm, at least 3,750 μm, at least 4000 μm, at least 4,250 μm, at least 4,500 μm, at least 4,750 μm, or at least 5,000 μm. In some embodiments, the thickness of the layer of the crosslinked polymer electrode 200 is at most 15 μm, at most 25 μm, at most 50 μm, at most 100 μm, at most 175 μm, at most 250 μm, at most 750 μm, at most 1,000 μm, at most 1,250 μm, at most 1,500 μm, at most 1,750 μm, at most 2,000 μm, at most 2,250 μm, at most 2,500 μm, at most 2,750 μm, at most 3,000 μm, at most 3,250 μm, at most 3,500 μm, at most 3,750 μm, at most 4000 μm, at most 4,250 μm, at most 4,500 μm, at most 4,750 μm, or at most 5,000 μm.

Accordingly, the crosslinked polymer electrode 200 of the present disclosure is capable of being formed in a variety of shapes and/or thicknesses. Advantageously, this flexibility in shape and size of the crosslinked polymer electrode 200 allows for the electronic device to be incorporated into wearable clothing that performs computational analysis.

In some embodiments, the crosslinked polymer electrode 200 is disposed as a layer folded into one or more folds (e.g., fold 400 of FIG. 4, etc.) on a surface of the substrate 300. In some embodiments, the one or more folds includes one or more alternating folds. In some embodiments, the crosslinked polymer electrode comprises one or more folded layers formed on the substrate. For instance, in some embodiments, an exterior surface of the crosslinked polymer electrode 200 includes one or more folds that allow for crosslinked polymer electrode 200 to change shapes and compressor and/or stretch when deformed in the Z-direction (e.g., perpendicular or substantially perpendicular to gravity). As a non-limiting example, in some embodiments, the one or more folds, the one or more creases, the one or more openings, or the combination thereof define portions of the crosslinked polymer electrode 200 that allow for in-plane and out-of-plane deformation, such as the one or more folds of origami or the one or more folds and the one or more openings of kirigami. Moreover, in some embodiments, the one or more folds, the one or more creases, the one or more openings, or the combination thereof is formed in an array on the crosslinked polymer electrode 200, which allows for the formation of complex two-dimensional or three-dimensional patterns, such as hyperbolic paraboloid (e.g., with negative curvature, positive curvature, or mixed curvature, which allow for flat-folding, forming a saddle shape with negative Gaussian curvature upon non-planar bending, rotatable upon anti-symmetric out-of-plane deformation, or a combination thereof. For instance, in some embodiments, the one or more folds, the one or more creases, the one or more openings, or the combination thereof is formed in a tessellated array, which is a tiling of a plane using one or more geometric shapes, hereinafter “tiles,” with no overlaps or gaps therebetween on the crosslinked polymer electrode 200. For instance, in some implementations the tessellation of a region refers to the tiling of a plane, or surface, which defines the region (e.g., the tessellation of a plane in a two-dimensional polar coordinate system, the tessellation of a surface in a three-dimensional spherical coordinate system, etc.). Additional details and information regarding the use of origami or kirigami to define the one or more folds, the one or more creases, the one or more openings, or the combination thereof is found at Rafsanjani et al., 2017, “Buckling-induced kirigami,” Physical Review Letters, 118(8), pg. 084301; Choi et al., 2019, “Programming shape using kirigami tessellations,” Nature Materials, 18(9), pg. 999-1004, each of which is hereby incorporated by reference in its entirety for all purposes.

Now that a general topology of the electronic device 100 and the crosslinked polymer electrode 200 has been described in accordance with various embodiments of the present disclosure, details regarding some processes in accordance with FIGS. 5A through 5C will be described. Specifically, FIGS. 5A through 5C collectively illustrate a flow chart of methods (e.g., method 500) for synthesizing a crosslinked polymer, in accordance with embodiments of the present disclosure.

Block 500. Referring to block 500 of FIG. 5A, in some embodiments, a method 500 of synthesizing a crosslinked polymer, optionally in the form of an electrode (e.g., crosslinked polymer electrode 200 of FIG. 2, crosslinked polymer electrode 200 of FIG. 3, crosslinked polymer electrode 200 of FIG. 4, crosslinked polymer electrode 200-1 of FIG. 6, crosslinked polymer electrode 200-2 of FIG. 6, crosslinked polymer electrode 200 of FIG. 7, crosslinked polymer electrode 200 of FIG. 8, crosslinked polymer electrode 200 of FIG. 9, etc.) is provided.

Block 502. Referring to block 502, in some embodiments, the method includes meltmixing methylvinyl silicone rubber (MVQ) and urethane acrylate together, which forms a solution. For instance, MVQ is an elastomeric material with high backbone flexibility, which provides for improved resilience and heat resistance properties. For instance, in some embodiments, the MVQ and the urethane acrylate are linearly crosslinked during the meltmixing, which forms the solution. As non-limiting example, in some embodiments, the MVQ and the urethane acrylate are dissolved when subjected to mechanical stirring in the presence of heat, thereby forming the solution. In some embodiments, the meltmixing of the MVW and the urethane acrylate is conducted until the solution provides a stable melt flow (e.g., stable viscosity under constant load and shear rates). In this way, the meltmixing of the MVQ with the urethane acrylate causes the urethane acrylate to couple with a vinyl group of the MVQ, such as through thiolene “click” chemistry. Additional details and information regarding the crosslinking of a polymer is found in Zhao et al., 2023, “Boronic ester-based vitrimeric methylvinyl silicone elastomer with ‘solid-liquid’ feature and rate-dependent mechanical performance,” Polymer, (365) pg. 125545, which is hereby incorporated by reference in its entirety for all purposes.

In some embodiments, the MVQ has a vinyl content of between 0.05 percent (%) and 5%. For instance, in some embodiments, the vinyl content of the MVQ is between 0.05% and 5%, between 0.05% and 4.5%, between 0.05% and 4%, between 0.05% and 3.5%, between 0.05% and 3%, between 0.05% and 2.5%, between 0.05% and 2%, between 0.05% and 1.5%, between 0.05% and 1%, between 0.05% and 0.5%, between 0.25% and 5%, between 0.25% and 4.5%, between 0.25% and 4%, between 0.25% and 3.5%, between 0.25% and 3%, between 0.25% and 2.5%, between 0.25% and 2%, between 0.25% and 1.5%, between 0.25% and 1%, between 0.25% and 0.5%, between 0.75% and 5%, between 0.75% and 4.5%, between 0.75% and 4%, between 0.75% and 3.5%, between 0.75% and 3%, between 0.75% and 2.5%, between 0.75% and 2%, between 0.75% and 1.5%, between 0.75% and 1%, between 1.75% and 5%, between 1.75% and 4.5%, between 1.75% and 4%, between 1.75% and 3.5%, between 1.75% and 3%, between 1.75% and 2.5%, between 1.75% and 2%, between 2.5% and 5%, between 2.5% and 4.5%, between 2.5% and 4%, between 2.5% and 3.5%, between 2.5% and 3%, between 3.4% and 5%, between 3.4% and 4.5%, between 3.4% and 4%, between 3.4% and 3.5%, between 4.2% and 5%, or between 4.2% and 4.5%.

In some embodiments, the vinyl content of the MVQ is at most 0.05%, at most 0.1%, at most 0.15%, at most 0.2%, at most 0.25%, at most 0.3%, at most 0.4%, at most 0.6%, at most 0.8%, at most 1%, at most 1.2%, at most 1.4%, at most 1.6%, at most 1.8%, at most 2%, at most 2.2%, at most 2.4%, at most 2.6%, at most 2.8%, at most 3%, at most 3.2%, at most 3.4%, at most 3.6%, at most 3.8%, at most 4%, at most 4.2%, at most 4.4%, at most 4.6%, at most 4.8%, or at most 5%. In some embodiments, the vinyl content of the MVQ is at most 0.05%, at most 0.1%, at most 0.15%, at most 0.2%, at most 0.25%, at most 0.3%, at most 0.4%, at most 0.6%, at most 0.8%, at most 1%, at most 1.2%, at most 1.4%, at most 1.6%, at most 1.8%, at most 2%, at most 2.2%, at most 2.4%, at most 2.6%, at most 2.8%, at most 3%, at most 3.2%, at most 3.4%, at most 3.6%, at most 3.8%, at most 4%, at most 4.2%, at most 4.4%, at most 4.6%, at most 4.8%, or at most 5%.

Moreover, in some embodiments, the urethane acrylate is at a temperature of between 125° C. and 225° C., such as when forming the solution. For instance, in some embodiments, the temperature of the urethane arylate is between 125° C. and 225° C., between 125° C. and 220° C., between 125° C. and 210° C., between 125° C. and 200° C., between 125° C. and 190° C., between 125° C. and 180° C., between 125° C. and 170° C., between 125° C. and 160° C., between 125° C. and 150° C., between 125° C. and 140° C., between 125° C. and 130° C., between 135° C. and 225° C., between 135° C. and 220° C., between 135° C. and 210° C., between 135° C. and 200° C., between 135° C. and 190° C., between 135° C. and 180° C., between 135° C. and 170° C., between 135° C. and 160° C., between 135° C. and 150° C., between 135° C. and 140° C., between 145° C. and 225° C., between 145° C. and 220° C., between 145° C. and 210° C., between 145° C. and 200° C., between 145° C. and 190° C., between 145° C. and 180° C., between 145° C. and 170° C., between 145° C. and 160° C., between 145° C. and 150° C., between 155° C. and 225° C., between 155° C. and 220° C., between 155° C. and 210° C., between 155° C. and 200° C., between 155° C. and 190° C., between 155° C. and 180° C., between 155° C. and 170° C., between 155° C. and 160° C., between 165° C. and 225° C., between 165° C. and 220° C., between 165° C. and 210° C., between 165° C. and 200° C., between 165° C. and 190° C., between 165° C. and 180° C., between 165° C. and 170° C., between 175° C. and 225° C., between 175° C. and 220° C., between 175° C. and 210° C., between 175° C. and 200° C., between 175° C. and 190° C., between 175° C. and 180° C., between 185° C. and 225° C., between 185° C. and 220° C., between 185° C. and 210° C., between 185° C. and 200° C., between 185° C. and 190° C., between 195° C. and 225° C., between 195° C. and 220° C., between 195° C. and 210° C., between 195° C. and 200° C., between 205° C. and 225° C., between 205° C. and 220° C., between 205° C. and 210° C., between 215° C. and 225° C., or between 215° C. and 220° C.

In some embodiments, the temperature of the urethane acrylate is at most 125° C., at most 130° C., at most 135° C., at most 140° C., at most 145° C., at most 150° C., at most 155° C., at most 160° C., at most 165° C., at most 170° C., at most 175° C., at most 180° C., at most 185° C., at most 190° C., at most 195° C., at most 200° C., at most 205° C., at most 210° C., at most 215° C., at most 220° C., or at most 225° C. In some embodiments, the temperature of the urethane acrylate is at most 125° C., at most 130° C., at most 135° C., at most 140° C., at most 145° C., at most 150° C., at most 155° C., at most 160° C., at most 165° C., at most 170° C., at most 175° C., at most 180° C., at most 185° C., at most 190° C., at most 195° C., at most 200° C., at most 205° C., at most 210° C., at most 215° C., at most 220° C., or at most 225° C.

Furthermore, in some embodiments, the MVG to urethane acrylate wt/wt ratio is between 1:1 and 1000:1 at initiation of the meltmixing. For instance, in some embodiments, prior to the forming of the solution by meltmixing the MVQ and the urethane acrylate, the MVG to urethane acrylate wt/wt ratio is between 1:10 and 1000:1, between 1:10 and 900:1, between 1:10 and 800:1, between 1:10 and 700:1, between 1:10 and 600:1, between 1:10 and 500:1, between 1:10 and 400:1, between 1:10 and 300:1, between 1:10 and 200:1, between 1:10 and 100:1, between 1:10 and 50:1, between 1:10 and 25:1, between 1:1 and 1000:1, between 1:1 and 900:1, between 1:1 and 800:1, between 1:1 and 700:1, between 1:1 and 600:1, between 1:1 and 500:1, between 1:1 and 400:1, between 1:1 and 300:1, between 1:1 and 200:1, between 1:1 and 100:1, between 1:1 and 50:1, between 1:1 and 10:1, between 5:1 and 1000:1, between 5:1 and 900:1, between 5:1 and 800:1, between 5:1 and 700:1, between 5:1 and 600:1, between 5:1 and 500:1, between 5:1 and 400:1, between 5:1 and 300:1, between 5:1 and 200:1, between 5:1 and 100:1, between 5:1 and 50:1, between 5:1 and 10:1, between 25:1 and 1000:1, between 25:1 and 900:1, between 25:1 and 800:1, between 25:1 and 700:1, between 25:1 and 600:1, between 25:1 and 500:1, between 25:1 and 400:1, between 25:1 and 300:1, between 25:1 and 200:1, between 25:1 and 100:1, between 25:1 and 50:1, between 125:1 and 1000:1, between 125:1 and 900:1, between 125:1 and 800:1, between 125:1 and 700:1, between 125:1 and 600:1, between 125:1 and 500:1, between 125:1 and 400:1, between 125:1 and 300:1, between 125:1 and 200:1, between 350:1 and 1000:1, between 350:1 and 900:1, between 350:1 and 800:1, between 350:1 and 700:1, between 350:1 and 600:1, between 350:1 and 500:1, between 350:1 and 400:1, between 525:1 and 1000:1, between 525:1 and 900:1, between 525:1 and 800:1, between 525:1 and 700:1, between 525:1 and 600:1, between 750:1 and 1000:1, between 750:1 and 900:1, or between 750:1 and 800:1.

In some embodiments, the MVG to urethane acrylate wt/wt ratio is at most 1:1, at most 2:1, at most 4:1, at most 5:1, at most 7:1, at most 10:1, at most 15:1, at most 25:1, at most 50:1, at most 100:1, at most 150:1, at most 500:1, at most 550:1, at most 300:1, at most 350:1, at most 400:1, at most 450:1, at most 500:1, at most 550:1, at most 600:1, at most 650:1, at most 700:1, at most 750:1, at most 800:1, at most 850:1, at most 900:1, at most 950:1, or at most 1,000:1. In some embodiments, the MVG to urethane acrylate wt/wt ratio is at most 1:1, at most 2:1, at most 4:1, at most 5:1, at most 7:1, at most 10:1, at most 15:1, at most 25:1, at most 50:1, at most 100:1, at most 150:1, at most 500:1, at most 550:1, at most 300:1, at most 350:1, at most 400:1, at most 450:1, at most 500:1, at most 550:1, at most 600:1, at most 650:1, at most 700:1, at most 750:1, at most 800:1, at most 850:1, at most 900:1, at most 950:1, or at most 1,000:1.

Block 504. Referring to block 504, in some embodiments, the urethane acrylate has an average molecular weight of between 1,000 g/mole and 5,000 g/mole, between 1,000 g/mole and 4,500 g/mole, between 1,000 g/mole and 4,000 g/mole, between 1,000 g/mole and 3,500 g/mole, between 1,000 g/mole and 3,000 g/mole, between 1,000 g/mole and 2,500 g/mole, between 1,000 g/mole and 2,000 g/mole, between 1,000 g/mole and 1,500 g/mole, between 1,600 g/mole and 5,000 g/mole, between 1,600 g/mole and 4,500 g/mole, between 1,600 g/mole and 4,000 g/mole, between 1,600 g/mole and 3,500 g/mole, between 1,600 g/mole and 3,000 g/mole, between 1,600 g/mole and 2,500 g/mole, between 1,600 g/mole and 2,000 g/mole, between 2,200 g/mole and 5,000 g/mole, between 2,200 g/mole and 4,500 g/mole, between 2,200 g/mole and 4,000 g/mole, between 2,200 g/mole and 3,500 g/mole, between 2,200 g/mole and 3,000 g/mole, between 2,200 g/mole and 2,500 g/mole, between 2,800 g/mole and 5,000 g/mole, between 2,800 g/mole and 4,500 g/mole, between 2,800 g/mole and 4,000 g/mole, between 2,800 g/mole and 3,500 g/mole, between 2,800 g/mole and 3,000 g/mole, between 3,400 g/mole and 5,000 g/mole, between 3,400 g/mole and 4,500 g/mole, between 3,400 g/mole and 4,000 g/mole, between 3,400 g/mole and 3,500 g/mole, between 4,100 g/mole and 5,000 g/mole, between 4,100 g/mole and 4,500 g/mole, or between 4,600 g/mole and 5,000 g/mole.

In some embodiments, the average molecular weight of the urethane acrylate is at most 1,000 g/mole, at most 1,200 g/mole, at most 1,400 g/mole, at most 1,600 g/mole, at most 1,800 g/mole, at most 2,000 g/mole, at most 2,200 g/mole, at most 2,400 g/mole, at most 2,600 g/mole, at most 2,800 g/mole, at most 3,000 g/mole, at most 3,200 g/mole, at most 3,400 g/mole, at most 3,600 g/mole, at most 3,800 g/mole, at most 4,000 g/mole, at most 4,200 g/mole, at most 4,400 g/mole, at most 4,600 g/mole, at most 4,800 g/mole, or at most 5,000 g/mole. In some embodiments, the average molecular weight of the urethane acrylate is at most 1,000 g/mole, at most 1,200 g/mole, at most 1,400 g/mole, at most 1,600 g/mole, at most 1,800 g/mole, at most 2,000 g/mole, at most 2,200 g/mole, at most 2,400 g/mole, at most 2,600 g/mole, at most 2,800 g/mole, at most 3,000 g/mole, at most 3,200 g/mole, at most 3,400 g/mole, at most 3,600 g/mole, at most 3,800 g/mole, at most 4,000 g/mole, at most 4,200 g/mole, at most 4,400 g/mole, at most 4,600 g/mole, at most 4,800 g/mole, or at most 5,000 g/mole.

Block 506. Referring to block 506, in some embodiments, the MVQ has an average molecular weight of between 500 g/mole and 900,000 g/mole, between 500 g/mole and 800,000 g/mole, between 500 g/mole and 700,000 g/mole, between 500 g/mole and 600,000 g/mole, between 500 g/mole and 500,000 g/mole, between 500 g/mole and 400,000 g/mole, between 500 g/mole and 100,000 g/mole, between 500 g/mole and 10,000 g/mole, between 500 g/mole and 5,000 g/mole, between 500 g/mole and 1,000 g/mole, between 500 g/mole and 750 g/mole, between 1,500 g/mole and 900,000 g/mole, between 1,500 g/mole and 800,000 g/mole, between 1,500 g/mole and 700,000 g/mole, between 1,500 g/mole and 600,000 g/mole, between 1,500 g/mole and 500,000 g/mole, between 1,500 g/mole and 400,000 g/mole, between 1,500 g/mole and 100,000 g/mole, between 1,500 g/mole and 10,000 g/mole, between 1,500 g/mole and 5,000 g/mole, between 7,000 g/mole and 900,000 g/mole, between 7,000 g/mole and 800,000 g/mole, between 7,000 g/mole and 700,000 g/mole, between 7,000 g/mole and 600,000 g/mole, between 7,000 g/mole and 500,000 g/mole, between 7,000 g/mole and 400,000 g/mole, between 7,000 g/mole and 100,000 g/mole, between 7,000 g/mole and 10,000 g/mole, between 40,000 g/mole and 900,000 g/mole, between 40,000 g/mole and 800,000 g/mole, between 40,000 g/mole and 700,000 g/mole, between 40,000 g/mole and 600,000 g/mole, between 40,000 g/mole and 500,000 g/mole, between 40,000 g/mole and 400,000 g/mole, between 40,000 g/mole and 100,000 g/mole, between 140,000 g/mole and 900,000 g/mole, between 140,000 g/mole and 800,000 g/mole, between 140,000 g/mole and 700,000 g/mole, between 140,000 g/mole and 600,000 g/mole, between 140,000 g/mole and 500,000 g/mole, between 140,000 g/mole and 400,000 g/mole, between 300,000 g/mole and 900,000 g/mole, between 300,000 g/mole and 800,000 g/mole, between 300,000 g/mole and 700,000 g/mole, between 300,000 g/mole and 600,000 g/mole, between 300,000 g/mole and 500,000 g/mole, between 300,000 g/mole and 400,000 g/mole, between 400,000 g/mole and 900,000 g/mole, between 400,000 g/mole and 800,000 g/mole, between 400,000 g/mole and 700,000 g/mole, between 400,000 g/mole and 600,000 g/mole, between 400,000 g/mole and 500,000 g/mole, between 500,000 g/mole and 900,000 g/mole, between 500,000 g/mole and 800,000 g/mole, between 500,000 g/mole and 700,000 g/mole, between 500,000 g/mole and 600,000 g/mole, between 600,000 g/mole and 900,000 g/mole, between 600,000 g/mole and 800,000 g/mole, between 600,000 g/mole and 700,000 g/mole, between 700,000 g/mole and 900,000 g/mole, between 700,000 g/mole and 800,000 g/mole, or between 800,000 g/mole and 900,000 g/mole.

In some embodiments, the average molecular weight of the MVQ is at least 500 g/mole, at least 750 g/mole, at least 1,000 g/mole, at least 1,500 g/mole, at least 2,500 g/mole, at least 5,000 g/mole, at least 10,000 g/mole, at least 50,000 g/mole, at least 100,000 g/mole, at least 200,000 g/mole, at least 250,000 g/mole, at least 300,000 g/mole, at least 350,000 g/mole, at least 400,000 g/mole, at least 450,000 g/mole, at least 500,000 g/mole, at least 550,000 g/mole, at least 600,000 g/mole, at least 650,000 g/mole, at least 700,000 g/mole, at least 750,000 g/mole, at least 800,000 g/mole, at least 850,000 g/mole, or at least 900,000 g/mole. In some embodiments, the average molecular weight of the MVQ is at most 500 g/mole, at most 750 g/mole, at most 1,000 g/mole, at most 1,500 g/mole, at most 2,500 g/mole, at most 5,000 g/mole, at most 10,000 g/mole, at most 50,000 g/mole, at most 100,000 g/mole, at most 200,000 g/mole, at most 250,000 g/mole, at most 300,000 g/mole, at most 350,000 g/mole, at most 400,000 g/mole, at most 450,000 g/mole, at most 500,000 g/mole, at most 550,000 g/mole, at most 600,000 g/mole, at most 650,000 g/mole, at most 700,000 g/mole, at most 750,000 g/mole, at most 800,000 g/mole, at most 850,000 g/mole, or at most 900,000 g/mole.

Block 508. Referring to block 508, in some embodiments, the method 500 includes adding a peroxide to the solution. In some embodiments, by adding the peroxide to the solution, free radicals are produced within the solution, which forms the crosslinked polymer electrode in which the MVQ is cross-linked with urethane acrylate. For instance, in some embodiments, the peroxide undergoes thermal decomposition in the free radicals when added to the solution, which attacks the vinyl groups of the MVQ in order to cure the solution and form the crosslinked polymer electrode 200 by covalent boding between the MVQ and the urethane acrylate. Accordingly, in some such embodiments, by adding the peroxide to the solution, the crosslinked polymer electrode 200 is formed with both the MVQ and the urethane in a cured state with liquid-like behave at room temperature (e.g., between about 20° C. to about 22° C.). However, the present disclosure is not limited thereto. For instance, in some embodiments, the crosslinked polymer electrode 200 is formed in a solid state, such as a continuous solid state.

In some embodiments, the peroxide is added to the solution while mixing the solution. For instance, in some embodiments, the peroxide is added to the solution and reactively processed in order to catalyze the crosslinking between the MVQ and the urethane acrylate.

In some embodiments, the peroxide is added to the solution at between 0.1 wt % to 5 wt %. For instance, in some embodiments, the peroxide is added to the solution at between 0.1 wt % to 5 wt %, between 0.1 wt % to 4.5 wt %, between 0.1 wt % to 4 wt %, between 0.1 wt % to 3.5 wt %, between 0.1 wt % to 3 wt %, between 0.1 wt % to 2.5 wt %, between 0.1 wt % to 2 wt %, between 0.1 wt % to 1.5 wt %, between 0.1 wt % to 1 wt %, between 0.1 wt % to 0.5 wt %, between 0.8 wt % to 5 wt %, between 0.8 wt % to 4.5 wt %, between 0.8 wt % to 4 wt %, between 0.8 wt % to 3.5 wt %, between 0.8 wt % to 3 wt %, between 0.8 wt % to 2.5 wt %, between 0.8 wt % to 2 wt %, between 0.8 wt % to 1.5 wt %, between 0.8 wt % to 1 wt %, between 1.6 wt % to 5 wt %, between 1.6 wt % to 4.5 wt %, between 1.6 wt % to 4 wt %, between 1.6 wt % to 3.5 wt %, between 1.6 wt % to 3 wt %, between 1.6 wt % to 2.5 wt %, between 1.6 wt % to 2 wt %, between 2.4 wt % to 5 wt %, between 2.4 wt % to 4.5 wt %, between 2.4 wt % to 4 wt %, between 2.4 wt % to 3.5 wt %, between 2.4 wt % to 3 wt %, between 2.4 wt % to 2.5 wt %, between 3.2 wt % to 5 wt %, between 3.2 wt % to 4.5 wt %, between 3.2 wt % to 4 wt %, between 3.2 wt % to 3.5 wt %, between 4 wt % to 5 wt %, between 4 wt % to 4.5 wt %, or between 4.8 wt % to 5 wt %.

In some embodiments, the peroxide is added to the solution at at most 0.1 wt %, at most 0.3 wt %, at most 0.5 wt %, at most 0.7 wt %, at most 0.9 wt %, at most 1.1 wt %, at most 1.3 wt %, at most 1.5 wt %, at most 1.7 wt %, at most 1.9 wt %, at most 2.1 wt %, at most 2.3 wt %, at most 2.5 wt %, at most 2.7 wt %, at most 2.9 wt %, at most 3.1 wt %, at most 3.3 wt %, at most 3.5 wt %, at most 3.7 wt %, at most 3.9 wt %, at most 4.1 wt %, at most 4.3 wt %, at most 4.5 wt %, at most 4.7 wt %, at most 4.9 wt %, or at most 5.0 wt %. In some embodiments, the peroxide is added to the solution at at most 0.1 wt %, at most 0.3 wt %, at most 0.5 wt %, at most 0.7 wt %, at most 0.9 wt %, at most 1.1 wt %, at most 1.3 wt %, at most 1.5 wt %, at most 1.7 wt %, at most 1.9 wt %, at most 2.1 wt %, at most 2.3 wt %, at most 2.5 wt %, at most 2.7 wt %, at most 2.9 wt %, at most 3.1 wt %, at most 3.3 wt %, at most 3.5 wt %, at most 3.7 wt %, at most 3.9 wt %, at most 4.1 wt %, at most 4.3 wt %, at most 4.5 wt %, at most 4.7 wt %, at most 4.9 wt %, or at most 5.0 wt %.

In some embodiments, the crosslinked polymer electrode 200 has a Young's modulus of between 0.5 MPa and 24 GPa, between 0.5 MPa and 22 GPa, between 0.5 MPa and 20 GPa, between 0.5 MPa and 18 GPa, between 0.5 MPa and 16 GPa, between 0.5 MPa and 15 GPa, between 0.5 MPa and 12 GPa, between 0.5 MPa and 10 GPa, between 0.5 MPa and 8 GPa, between 0.5 MPa and 6 GPa, between 0.5 MPa and 4 GPa, between 0.5 MPa and 2 GPa, between 0.5 MPa and 1 GPa, between 0.5 MPa and 800 MPa, between 0.5 MPa and 500 MPa, between 0.5 MPa and 150 MPa, between 0.5 MPa and 50 MPa, between 15 MPa and 24 GPa, between 15 MPa and 22 GPa, between 15 MPa and 20 GPa, between 15 MPa and 18 GPa, between 15 MPa and 16 GPa, between 15 MPa and 15 GPa, between 15 MPa and 12 GPa, between 15 MPa and 10 GPa, between 15 MPa and 8 GPa, between 15 MPa and 6 GPa, between 15 MPa and 4 GPa, between 15 MPa and 2 GPa, between 15 MPa and 1 GPa, between 15 MPa and 800 MPa, between 15 MPa and 500 MPa, between 15 MPa and 150 MPa, between 15 MPa and 50 MPa, between 750 MPa and 24 GPa, between 750 MPa and 22 GPa, between 750 MPa and 20 GPa, between 750 MPa and 18 GPa, between 750 MPa and 16 GPa, between 750 MPa and 15 GPa, between 750 MPa and 12 GPa, between 750 MPa and 10 GPa, between 750 MPa and 8 GPa, between 750 MPa and 6 GPa, between 750 MPa and 4 GPa, between 750 MPa and 2 GPa, between 750 MPa and 1 GPa, between 750 MPa and 800 MPa, between 1,600 MPa and 24 GPa, between 1,600 MPa and 22 GPa, between 1,600 MPa and 20 GPa, between 1,600 MPa and 18 GPa, between 1,600 MPa and 16 GPa, between 1,600 MPa and 15 GPa, between 1,600 MPa and 12 GPa, between 1,600 MPa and 10 GPa, between 1,600 MPa and 8 GPa, between 1,600 MPa and 6 GPa, between 1,600 MPa and 4 GPa, between 1,600 MPa and 2 GPa, between 2,700 MPa and 24 GPa, between 2,700 MPa and 22 GPa, between 2,700 MPa and 20 GPa, between 2,700 MPa and 18 GPa, between 2,700 MPa and 16 GPa, between 2,700 MPa and 15 GPa, between 2,700 MPa and 12 GPa, between 2,700 MPa and 10 GPa, between 2,700 MPa and 8 GPa, between 2,700 MPa and 6 GPa, between 2,700 MPa and 4 GPa, 10 GPa and 24 GPa, between 10 GPa and 22 GPa, between 10 GPa and 20 GPa, between 10 GPa and 18 GPa, between 10 GPa and 16 GPa, between 10 GPa and 15 GPa, between 10 GPa and 12 GPa, between 12 GPa and 24 GPa, between 12 GPa and 22 GPa, between 12 GPa and 20 GPa, between 12 GPa and 18 GPa, between 12 GPa and 16 GPa, between 12 GPa and 15 GPa, between 14 GPa and 24 GPa, between 14 GPa and 22 GPa, between 14 GPa and 20 GPa, between 14 GPa and 18 GPa, between 14 GPa and 16 GPa, between 16 GPa and 24 GPa, between 16 GPa and 22 GPa, between 16 GPa and 20 GPa, between 16 GPa and 18 GPa, between 18 GPa and 24 GPa, between 18 GPa and 22 GPa, between 18 GPa and 20 GPa, between 20 GPa and 24 GPa, between 20 GPa and 22 GPa, or between 22 GPa and 24 GPa.

In some embodiments, the crosslinked polymer electrode 200 has a Young's modulus of at least 0.5 MPa, at least 1 MPa, at least 5 MPa, at least 10 MPa, at least 50 MPa, at least 100 MPa, at least 200 MPa, at least 300 MPa, at least 400 MPa, at least 500 MPa, at least 600 MPa, at least 800 MPa, at least 1 GPa, at least 1.2 GPa, at least 1.5 GPa, at least 3 GPa, at least 5 GPa, at least 7 GPa, at least 9 GPa, 10 GPa, at least 11 GPa, at least 12 GPa, at least 13 GPa, at least 14 GPa, at least 15 GPa, at least 16 GPa, at least 17 GPa, at least 18 GPa, at least 19 GPa, at least 20 GPa, at least 21 GPa, at least 22 GPa, at least 23 GPa, or at least 24 GPa. In some embodiments, the crosslinked polymer electrode 200 has a Young's modulus of at most 0.5 MPa, at most 1 MPa, at most 5 MPa, at most 10 MPa, at most 50 MPa, at most 100 MPa, at most 200 MPa, at most 300 MPa, at most 400 MPa, at most 500 MPa, at most 600 MPa, at most 800 MPa, at most 1 GPa, at most 1.2 GPa, at most 1.5 GPa, at most 3 GPa, at most 5 GPa, at most 7 GPa, at most 9 GPa, at most 10 GPa, at most 11 GPa, at most 12 GPa, at most 13 GPa, at most 14 GPa, at most 15 GPa, at most 16 GPa, at most 17 GPa, at most 18 GPa, at most 19 GPa, at most 20 GPa, at most 21 GPa, at most 22 GPa, at most 23 GPa, or at most 24 GPa.

In some embodiments, the modulus is selected from a Young's modulus (E), a shear modulus or a modulus of rigidity (G), and a bulk modulus (K). The Young's modulus is utilized to measure a stiffness of a solid, or approximately solid, material as determined by an experienced stress and strain through a uniaxial deformation of the material. A smaller Young's modulus (e.g., a number closer to zero) describes a material with a low stiffness (e.g., a high extensibility such as small strain rubber which has a Young's modulus of approximately 0.01 to 0.1 Giga-Pascal's (GPa)), while a larger Young's modulus (e.g., a number further from zero) describes a material with a high stiffness (e.g., a low extensibility such as diamond which has a Young's modulus of approximately 1050 to 1210 GPa,). For instance, low-density polyethylene has a Young's modulus of approximately 0.11 to 0.86 GPa, nylon has a Young's modulus of approximately 2 to 4 GPa, foam polystyrene has a Young's modulus of approximately 0.0025 to 0.007 GPa, hemp fiber has a Young's modulus of approximately 35 GPa, polyethylene terephthalate (PET) has a Young's modulus of approximately 2 to 2.7 GPa, and polypropylene has a Young's modulus of approximately 1.5 to 2 GPa, to name a few.

Block 510. Referring to block 510, in some embodiments, the peroxide is 2,5-di(tertbutylperoxy)-2,5-mercapropinoate (DBPH). However, the present disclosure is not limited thereto. For instance, in some embodiments, the peroxide is an organic peroxide, such as dicumyl peroxide (DCP).

Block 512. Referring to block 512, in some embodiments, the method 500 further includes adding an additive polymer having a conductance of between 0.0001 Siemens per centimeter (S/cm) and 100,000 S/cm to the solution during the adding step. For instance, in some embodiments, the conductance of the additive polymer is between 0.00001 S/cm and 100,000 S/cm, between 0.00001 S/cm and 50,000 S/cm, between 0.00001 S/cm and 1,000 S/cm, between 0.00001 S/cm and 50 S/cm, between 0.00001 S/cm and 1 S/cm, between 0.00001 S/cm and 0.1 S/cm, between 0.00001 S/cm and 0.001 S/cm, between 0.00001 S/cm and 0.001 S/cm, between 0.00001 S/cm and 0.0001 S/cm, between 0.001 S/cm and 100,000 S/cm, between 0.001 S/cm and 50,000 S/cm, between 0.001 S/cm and 1,000 S/cm, between 0.001 S/cm and 50 S/cm, between 0.001 S/cm and 1 S/cm, between 0.001 S/cm and 0.1 S/cm, between 0.001 S/cm and 0.001 S/cm, between 0.05 S/cm and 100,000 S/cm, between 0.05 S/cm and 50,000 S/cm, between 0.05 S/cm and 1,000 S/cm, between 0.05 S/cm and 50 S/cm, between 0.05 S/cm and 1 S/cm, between 0.05 S/cm and 0.1 S/cm, between 15 S/cm and 100,000 S/cm, between 15 S/cm and 50,000 S/cm, between 15 S/cm and 1,000 S/cm, between 15 S/cm and 50 S/cm, between 250 S/cm and 100,000 S/cm, between 250 S/cm and 50,000 S/cm, between 250 S/cm and 1,000 S/cm, between 12,500 S/cm and 100,000 S/cm, between 12,500 S/cm and 50,000 S/cm, or between 60,000 S/cm and 100,000 S/cm.

In some embodiments, the conductance of the additive polymer is at least 0.00001 S/cm, at least 0.0001 S/cm, at least 0.001 S/cm, at least 0.01 S/cm, at least 0.1 S/cm, at least 1 S/cm, at least 10 S/cm, at least 100 S/cm, at least 1,000 S/cm, at least 5,000 S/cm, at least 10,000 S/cm, at least 10,000 S/cm, at least 10,000 S/cm, at least 60,000 S/cm, at least 80,000 S/cm, at least 100,000 S/cm. In some embodiments, the conductance of the additive polymer is at most 0.00001 S/cm, at most 0.0001 S/cm, at most 0.001 S/cm, at most 0.01 S/cm, at most 0.1 S/cm, at most 1 S/cm, at most 10 S/cm, at most 100 S/cm, at most 1,000 S/cm, at most 5,000 S/cm, at most 10,000 S/cm, at most 10,000 S/cm, at most 10,000 S/cm, at most 60,000 S/cm, at most 80,000 S/cm, at most 100,000 S/cm.

In some embodiments, the additive polymer includes Poly(3-hexylthiophene) (P3HT), P3HT derivatives, polyaniline, polymer aniline derivatives, polypyrrole, polypyrrole derivatives, or a combination thereof.

Block 514. Referring to block 514, in some embodiments, the method 500 further includes adding one or more hydrophilic materials and/or one or more hygroscopic materials to the solution during the adding step. In some embodiments, the one or more hydrophilic materials and/or the one or more hygroscopic materials improve the impendence of the crosslinked polymer electrode 200 when contacting a subject utilizing or wearing the electronic device 100. Examples of hygroscopic materials include, but are not limited to, epoxy resins, polycarbonates, and poly (methyl methacrylate). Examples of hydrophilic materials include, but are not limited to, silicon dioxide, silicon nitride, phosphosilicate glass, quartz, and polyethylene glycol. Moreover, in some embodiments, the one or more hydrophilic materials and/or the one or more hygroscopic materials is solid. For instance, in some embodiments, the one or more hydrophilic materials and/or the one or more hygroscopic materials includes a hygroscopic substance that is used to induce or sustain a state of dryness (e.g., desiccation) in its vicinity, such as in order to absorb water. In some embodiments, the one or more hydrophilic materials and/or the one or more hygroscopic materials includes silica gel, activated charcoal, calcium sulfate, calcium chloride, molecular sieves (e.g., Zeolites), desiccant type I, desiccant type II, desiccant type III, desiccant type IV, desiccant type V, or a combination thereof. In which the different desiccant types are a function of the shape of the desiccant's moisture sorption isotherm. However, the present disclosure is not limited thereto.

Block 516. Referring to block 516, in some embodiments, the method 500 further includes adding one or more foaming agents to the solution during the adding step. In some embodiments, the one or more foaming agents improve the compressibility (e.g., z-compressibility) of the crosslinked polymer electrode 200. Examples of suitable foaming agents include, but are not limited to azodicarbonamide, sodium bicarbonate, and sodium laureth sulfate. In some embodiments, the one or more foaming agents include an inorganic foaming agent. In some embodiments, the inorganic foaming agent includes an inorganic thermal decomposition blowing agent (e.g., bicarbonate, carbonate, nitrite, or a combination thereof) or an inorganic reactive blowing agent (e.g., sodium bicarbonate, zinc powder, hydrogen peroxide, or a yeast reaction). In some embodiments, the one or more foaming agents includes an organic foaming agent. In some embodiments, the organic foaming agent includes an azo foaming agent, a nitroso foaming agent, an acylhydrazide foaming agent, or a combination thereof. In some embodiments, the one or more foaming agents includes a microbead (e.g., expanded polylactide beads, expanded glass beads, polystyrene beads, unexpanded microbeads, or a combination thereof).

Block 518. Referring to block 518, in some embodiments, the surface roughness average (Ra) of the surface of the crosslinked polymer electrode 200 is between 0.1 Ra and 3 Ra. For instance, in some embodiments, the surface Ra of the surface of the crosslinked polymer electrode 200 is between 0.1 Ra and 3 Ra, between 0.1 Ra and 2.5 Ra, between 0.1 Ra and 1 Ra, between 0.1 Ra and 1.5 Ra, between 0.1 Ra and 1 Ra, between 0.1 Ra and 0.9 Ra, between 0.1 Ra and 0.8 Ra, between 0.1 Ra and 0.7 Ra, between 0.1 Ra and 0.6 Ra, between 0.1 Ra and 0.5 Ra, between 0.1 Ra and 0.3 Ra, between 0.2 Ra and 3 Ra, between 0.2 Ra and 2.5 Ra, between 0.2 Ra and 1 Ra, between 0.2 Ra and 1.5 Ra, between 0.2 Ra and 1 Ra, between 0.2 Ra and 0.9 Ra, between 0.2 Ra and 0.8 Ra, between 0.2 Ra and 0.7 Ra, between 0.2 Ra and 0.6 Ra, between 0.2 Ra and 0.5 Ra, between 0.2 Ra and 0.3 Ra, between 0.4 Ra and 3 Ra, between 0.4 Ra and 2.5 Ra, between 0.4 Ra and 1 Ra, between 0.4 Ra and 1.5 Ra, between 0.4 Ra and 1 Ra, between 0.4 Ra and 0.9 Ra, between 0.4 Ra and 0.8 Ra, between 0.4 Ra and 0.7 Ra, between 0.4 Ra and 0.6 Ra, between 0.4 Ra and 0.5 Ra, between 0.45 Ra and 3 Ra, between 0.45 Ra and 2.5 Ra, between 0.45 Ra and 2 Ra, between 0.45 Ra and 1.5 Ra, between 0.45 Ra and 1 Ra, between 0.45 Ra and 0.9 Ra, between 0.45 Ra and 0.8 Ra, between 0.45 Ra and 0.7 Ra, between 0.45 Ra and 0.6 Ra, between 0.45 Ra and 0.5 Ra, between 0.55 Ra and 3 Ra, between 0.55 Ra and 2.5 Ra, between 0.55 Ra and 2 Ra, between 0.55 Ra and 1.5 Ra, between 0.55 Ra and 1 Ra, between 0.55 Ra and 0.9 Ra, between 0.55 Ra and 0.8 Ra, between 0.55 Ra and 0.7 Ra, between 0.55 Ra and 0.6 Ra, between 0.65 Ra and 3 Ra, between 0.65 Ra and 2.5 Ra, between 0.65 Ra and 2 Ra, between 0.65 Ra and 1.5 Ra, between 0.65 Ra and 1 Ra, between 0.65 Ra and 0.9 Ra, between 0.65 Ra and 0.8 Ra, between 0.65 Ra and 0.7 Ra, between 0.75 Ra and 3 Ra, between 0.75 Ra and 2.5 Ra, between 0.75 Ra and 2 Ra, between 0.75 Ra and 1.5 Ra, between 0.75 Ra and 1 Ra, between 0.75 Ra and 0.9 Ra, between 0.75 Ra and 0.8 Ra, between 0.85 Ra and 3 Ra, between 0.85 Ra and 2.5 Ra, between 0.85 Ra and 2 Ra, between 0.85 Ra and 1.5 Ra, between 0.85 Ra and 1 Ra, between 0.85 Ra and 0.9 Ra, between 0.95 Ra and 1 Ra, between 1 Ra and 3 Ra, between 1 Ra and 2.5 Ra, between 1 Ra and 2 Ra, between 1 Ra and 1.5 Ra, between 2 Ra and 3 Ra, or between 2 Ra and 2.5 Ra.

In some embodiments, the surface Ra of the surface of the crosslinked polymer electrode 200 is at least 0.1 Ra, at least 0.15 Ra, at least 0.2 Ra, at least 0.25 Ra, at least 0.3 Ra, at least 0.35 Ra, at least 0.4 Ra, at least 0.45 Ra, at least 0.5 Ra, at least 0.55 Ra, at least 0.6 Ra, at least 0.65 Ra, at least 0.7 Ra, at least 0.75 Ra, at least 0.8 Ra, at least 0.85 Ra, at least 0.9 Ra, at least 0.95 Ra, at least 1 Ra, at least 1.5 Ra, at least 2 Ra, at least 2.5 Ra, or at least 3 Ra. In some embodiments, the surface Ra of the first surface of the crosslinked polymer electrode 200 is at most 0.1 Ra, at most 0.15 Ra, at most 0.2 Ra, at most 0.25 Ra, at most 0.3 Ra, at most 0.35 Ra, at most 0.4 Ra, at most 0.45 Ra, at most 0.5 Ra, at most 0.55 Ra, at most 0.6 Ra, at most 0.65 Ra, at most 0.7 Ra, at most 0.75 Ra, at most 0.8 Ra, at most 0.85 Ra, at most 0.9 Ra, at most 0.95 Ra, at most 1 Ra, at most 1.5 Ra, at most 2 Ra, at most 2.5 Ra, or at most 3 Ra.

Block 520. Referring to block 520, in some embodiments, the resistivity of the crosslinked polymer electrode 200 is between 0.01 Ω-cm and 10 Ω-cm. For instance, in some embodiments, the resistivity of the crosslinked polymer electrode 200 is between 0.01 Ω-cm and 10 Ω-cm, between 0.01 Ω-cm and 7 Ω-cm, between 0.01 Ω-cm and 4 Ω-cm, between 0.01 Ω-cm and 2 Ω-cm, between 0.01 Ω-cm and 1 Ω-cm, between 0.01 Ω-cm and 0.5 Ω-cm, between 0.01 Ω-cm and 0.1 Ω-cm, between 0.01 Ω-cm and 0.05 Ω-cm, between 0.05 Ω-cm and 10 Ω-cm, between 0.05 Ω-cm and 7 Ω-cm, between 0.05 Ω-cm and 4 Ω-cm, between 0.05 Ω-cm and 2 Ω-cm, between 0.05 Ω-cm and 1 Ω-cm, between 0.05 Ω-cm and 0.5 Ω-cm, between 0.05 Ω-cm and 0.1 Ω-cm, between 0.1 Ω-cm and 10 Ω-cm, between 0.1 Ω-cm and 7 Ω-cm, between 0.1 Ω-cm and 4 Ω-cm, between 0.1 Ω-cm and 2 Ω-cm, between 0.1 Ω-cm and 1 Ω-cm, between 0.1 Ω-cm and 0.5 Ω-cm, between 0.5 Ω-cm and 10 Ω-cm, between 0.5 Ω-cm and 7 Ω-cm, between 0.5 Ω-cm and 4 Ω-cm, between 0.5 Ω-cm and 2 Ω-cm, between 0.5 Ω-cm and 1 Ωcm, between 1.6 Ω-cm and 10 Ω-cm, between 1.6 Ω-cm and 7 Ω-cm, between 1.6 Ω-cm and 4 Ω-cm, between 1.6 Ω-cm and 2 Ω-cm, between 5 Ω-cm and 10 Ω-cm, or between 5 Ω-cm and 7 Ω-cm.

In some embodiments, the resistivity of the crosslinked polymer electrode 200 is at least 0.001 Ω-cm, at least 0.005 Ω-cm, at least 0.01 Ω-cm, at least 0.05 Ω-cm, at least 0.1 Ω-cm, at least 0.5 Ω-cm, at least 1 Ω-cm, at least 1.5 Ω-cm, at least 2 Ω-cm, at least 2.5 Ω-cm, at least 3 Ω-cm, at least 3.5 Ω-cm, at least 4 Ω-cm, at least 4.5 Ω-cm, at least 5 Ω-cm, at least 5.5 Ω-cm, at least 6 Ω-cm, at least 6.5 Ω-cm, at least 7 Ω-cm, at least 7.5 Ω-cm, at least 8 Ω-cm, at least 8.5 Ω-cm, at least 9 Ω-cm, at least 9.5 Ω-cm, or at least 10 Ω-cm. In some embodiments, the resistivity of the crosslinked polymer electrode 200 is at most 0.001 Ω-cm, at most 0.005 Ω-cm, at most 0.01 Ω-cm, at most 0.05 Ω-cm, at most 0.1 Ω-cm, at most 0.5 Ω-cm, at most 1 Ω-cm, at most 1.5 Ω-cm, at most 2 Ω-cm, at most 2.5 Ω-cm, at most 3 Ω-cm, at most 3.5 Ω-cm, at most 4 Ω-cm, at most 4.5 Ω-cm, at most 5 Ω-cm, at most 5.5 Ω-cm, at most 6 Ω-cm, at most 6.5 Ω-cm, at most 7 Ω-cm, at most 7.5 Ω-cm, at most 8 Ω-cm, at most 8.5 Ω-cm, at most 9 Ω-cm, at most 9.5 Ω-cm, or at most 10 Ω-cm.

Block 522. Referring to block 522, in some embodiments, a Shore A hardness of the crosslinked polymer electrode 200 is between 20 and 95. For instance, in some embodiments, the crosslinked polymer electrode 200 has a Shore A hardness between 20 and 95, between 20 and 85, between 20 and 75, between 20 and 65, between 20 and 55, between 20 and 45, between 20 and 35, between 20 and 25, between 30 and 95, between 30 and 85, between 30 and 75, between 30 and 65, between 30 and 55, between 30 and 45, between 30 and 35, between 40 and 95, between 40 and 85, between 40 and 75, between 40 and 65, between 40 and 55, between 40 and 45, between 50 and 95, between 50 and 85, between 50 and 75, between 50 and 65, between 50 and 55, between 60 and 95, between 60 and 85, between 60 and 75, between 60 and 65, between 70 and 95, between 70 and 85, between 70 and 75, between 80 and 95, between 80 and 85, between 90 and 95.

In some embodiments, the Shore A hardness of the crosslinked polymer electrode 200 is at least 20, at least 25, at least 30, at least 35, at least 240, at least 5, at least 50, at least 55, at least 60, at least 65, at least 70, at least 75, at least 80, at least 85, at least 90, or at least 95. In some embodiments, the Shore A hardness of the crosslinked polymer electrode 200 is at most 20, at most 25, at most 30, at most 35, at most 240, at most 5, at most 50, at most 55, at most 60, at most 65, at most 70, at most 75, at most 80, at most 85, at most 90, or at most 95.

Block 524. Referring to block 524, in some embodiments, the abrasion resistance maximum loss of the crosslinked polymer electrode 200 is between 0 milligrams (mg) and 65 mg. For instance, in some embodiments, the crosslinked polymer electrode 200 has an abrasion resistance maximum loss of between 0 mg and 65 mg, between 0 mg and 60 mg, between 0 mg and 55 mg, between 0 mg and 50 mg, between 0 mg and 45 mg, between 0 mg and 40 mg, between 0 mg and 35 mg, between 0 mg and 30 mg, between 0 mg and 25 mg, between 0 mg and 20 mg, between 0 mg and 15 mg, between 0 mg and 10 mg, between 0 mg and 5 mg, between 7.5 mg and 65 mg, between 7.5 mg and 60 mg, between 7.5 mg and 55 mg, between 7.5 mg and 50 mg, between 7.5 mg and 45 mg, between 7.5 mg and 40 mg, between 7.5 mg and 35 mg, between 7.5 mg and 30 mg, between 7.5 mg and 25 mg, between 7.5 mg and 20 mg, between 7.5 mg and 15 mg, between 7.5 mg and 10 mg, between 14 mg and 65 mg, between 14 mg and 60 mg, between 14 mg and 55 mg, between 14 mg and 50 mg, between 14 mg and 45 mg, between 14 mg and 40 mg, between 14 mg and 35 mg, between 14 mg and 30 mg, between 14 mg and 25 mg, between 14 mg and 20 mg, between 14 mg and 15 mg, between 21 mg and 65 mg, between 21 mg and 60 mg, between 21 mg and 55 mg, between 21 mg and 50 mg, between 21 mg and 45 mg, between 21 mg and 40 mg, between 21 mg and 35 mg, between 21 mg and 30 mg, between 21 mg and 25 mg, between 28 mg and 65 mg, between 28 mg and 60 mg, between 28 mg and 55 mg, between 28 mg and 50 mg, between 28 mg and 45 mg, between 28 mg and 40 mg, between 28 mg and 35 mg, between 28 mg and 30 mg, between 35 mg and 65 mg, between 35 mg and 60 mg, between 35 mg and 55 mg, between 35 mg and 50 mg, between 35 mg and 45 mg, between 35 mg and 40 mg, between 42 mg and 65 mg, between 42 mg and 60 mg, between 42 mg and 55 mg, between 42 mg and 50 mg, between 42 mg and 45 mg, between 49 mg and 65 mg, between 49 mg and 60 mg, between 49 mg and 55 mg, between 49 mg and 50 mg, between 42 mg and 45 mg, between 56 mg and 65 mg, between 56 mg and 60 mg, between 63 mg and 65 mg,

In some embodiments, the crosslinked polymer electrode 200 has an abrasion resistance maximum loss of at most 0 mg, at most 2 mg, at most 4 mg, at most 6 mg, at most 8 mg, at most 10 mg, at most 12 mg, at most 14 mg, at most 16 mg, at most 18 mg, at most 20 mg, at most 22 mg, at most 24 mg, at most 26 mg, at most 28 mg, at most 30 mg, at most 32 mg, at most 34 mg, at most 36 mg, at most 38 mg, at most 40 mg, at most 42 mg, at most 44 mg, at most 46 mg, at most 48 mg, at most 50 mg, at most 52 mg, at most 54 mg, at most 56 mg, at most 58 mg, at most 60 mg, at most 62 mg, at most 64 mg, or at most 65 mg. In some embodiments, the crosslinked polymer electrode 200 has an abrasion resistance maximum loss of at most 0 mg, at most 2 mg, at most 4 mg, at most 6 mg, at most 8 mg, at most 10 mg, at most 12 mg, at most 14 mg, at most 16 mg, at most 18 mg, at most 20 mg, at most 22 mg, at most 24 mg, at most 26 mg, at most 28 mg, at most 30 mg, at most 32 mg, at most 34 mg, at most 36 mg, at most 38 mg, at most 40 mg, at most 42 mg, at most 44 mg, at most 46 mg, at most 48 mg, at most 50 mg, at most 52 mg, at most 54 mg, at most 56 mg, at most 58 mg, at most 60 mg, at most 62 mg, at most 64 mg, or at most 65 mg.

In some embodiments, the maximum loss of the crosslinked polymer electrode 200 during an abrasion resistance test is between 0 mg and 65 mg for a surface of the crosslinked polymer electrode 200 having a surface area of 33 square millimeters, in which the sample undergoes 3,000 cycles at a frequency of 60 cycles per minute with a 50 gram mass disposed on the surface in or to cause friction between the crosslinked polymer electrode 200 and another surface of a substrate.

Block 526. Referring to block 526, in some embodiments, the crosslinked polymer electrode 200 has a tensile strength between 2 MPa and 20 GPa (e.g., between 4 MPa and 20 MPa). For instance, in some embodiments, the tensile strength of the crosslinked polymer electrode is between 2 MPa and 20 GPa, between 2 MPa and 15 GPa, between 2 MPa and 10 GPa, between 2 MPa and 5 GPa, between 2 MPa and 1 GPa, between 2 MPa and 500 MPa, between 2 MPa and 100 MPa, between 2 MPa and 20 MPa, between 4 MPa and 20 GPa, between 4 MPa and 15 GPa, between 4 MPa and 10 GPa, between 4 MPa and 5 GPa, between 4 MPa and 1 GPa, between 4 MPa and 500 MPa, between 4 MPa and 100 MPa, between 4 MPa and 20 MPa, between 50 MPa and 20 GPa, between 50 MPa and 15 GPa, between 50 MPa and 10 GPa, between 50 MPa and 5 GPa, between 50 MPa and 1 GPa, between 50 MPa and 500 MPa, between 50 MPa and 100 MPa, between 700 MPa and 20 GPa, between 700 MPa and 15 GPa, between 700 MPa and 10 GPa, between 700 MPa and 5 GPa, between 700 MPa and 1 GPa, between 1.5 GPa and 20 GPa, between 1.5 GPa and 15 GPa, between 1.5 GPa and 10 GPa, between 1.5 GPa and 5 GPa, between 7.5 GPa and 20 GPa, between 7.5 GPa and 15 GPa, between 7.5 GPa and 10 GPa, between 12 GPa and 20 GPa, or between 12 GPa and 15 GPa.

In some embodiments, the tensile strength of the crosslinked polymer electrode is at least 2 MPa, at least 3 MPa, at least 4 MPa, at least 5 MPa, at least 8 MPa, at least 12 MPa, at least 15 MPa, at least 20 MPa, at least 50 MPa, at least 90 MPa, at least 200 MPa, at least 350 MPa, at least 600 MPa, at least 1 GPa, at least 2 GPa, at least 5 GPa, at least 10 GPa, at least 15 GPa, or at least 20 GPa. In some embodiments, the tensile strength of the crosslinked polymer electrode is at most 2 MPa, at most 3 MPa, at most 4 MPa, at most 5 MPa, at most 8 MPa, at most 12 MPa, at most 15 MPa, at most 20 MPa, at most 50 MPa, at most 90 MPa, at most 200 MPa, at most 350 MPa, at most 600 MPa, at most 1 GPa, at most 2 GPa, at most 5 GPa, at most 10 GPa, at most 15 GPa, or at most 20 GPa.

Block 5% 28. Referring to block 5% 28, in some embodiments, the compressibility of the crosslinked polymer electrode is between 20% and 90%. For instance, in some embodiments, the compressibility of the crosslinked polymer electrode 200 is between 20% and 90%, between 20% and 85%, between 20% and 75%, between 20% and 65%, between 20% and 5%, between 20% and 45%, between 20% and 35%, between 20% and 25%, between 30% and 90%, between 30% and 85%, between 30% and 75%, between 30% and 65%, between 30% and 5% 5%, between 30% and 45%, between 30% and 35%, between 40% and 90%, between 40% and 85%, between 40% and 80%, between 40% and 75%, between 40% and 65%, between 40% and 55%, between 40% and 45%, between 50% and 90%, between 50% and 85%, between 50% and 75%, between 50% and 65%, between 50% and 55%, between 60% and 90%, between 60% and 85%, between 60% and 75%, between 60% and 65%, between 70% and 90%, between 70% and 85%, between 70% and 75%, between 80% and 90%, or between 80% and 85%.

In some embodiments, the compressibility of the crosslinked polymer electrode 200 is at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%. In some embodiments, the compressibility of the crosslinked polymer electrode 200 is at most 20%, at most 25%, at most 30%, at most 35%, at most 40%, at most 45%, at most 50%, at most 55%, at most 60%, at most 65%, at most 70%, at most 75%, at most 80%, at most 85%, or at most 90%.

Block 530. Referring to block 530, in some embodiments, a maximum strain along a first axis of the crosslinked polymer electrode 200 is between 20% and 1,000% elongation. For instance, in some embodiments, the maximum strain along the first axis of the crosslinked polymer electrode 200 is between 20% and 1,000% elongation, between 20% and 700% elongation, between 20% and 500% elongation, between 20% and 300% elongation, between 20% and 100% elongation, between 20% and 70% elongation, between 20% and 30% elongation, between 50% and 1,000% elongation, between 50% and 700% elongation, between 50% and 500% elongation, between 50% and 300% elongation, between 50% and 100% elongation, between 50% and 70% elongation, between 150% and 1,000% elongation, between 150% and 700% elongation, between 150% and 500% elongation, between 150% and 300% elongation, between 500% and 1,000% elongation, or between 500% and 700% elongation.

In some embodiments, the maximum strain along the first axis of the crosslinked polymer electrode 200 is at least 20%, at least 25%, at least 30%, at least 50%, at least 70%, at least 90%, at least 100%, at least 150%, at least 200%, at least 250%, at least 300%, at least 350%, at least 400%, at least 450%, at least 500%, at least 550%, at least 600%, at least 650%, at least 700%, at least 750%, at least 800%, at least 850%, at least 900%, at least 950%, or at least 1,000%. In some embodiments, the maximum strain along the first axis of the crosslinked polymer electrode 200 is at most 20%, at most 25%, at most 30%, at most 50%, at most 70%, at most 90%, at most 100%, at most 150%, at most 200%, at most 250%, at most 300%, at most 350%, at most 400%, at most 450%, at most 500%, at most 550%, at most 600%, at most 650%, at most 700%, at most 750%, at most 800%, at most 850%, at most 900%, at most 950%, or at most 1,000%.

Block 532. Referring to block 532, in some embodiments, the method 500 further includes adding a filler to the solution during the adding step (e.g., block 508 of FIG. 5B). In some embodiments, the filler is a solid filler or a bi-phasic filler. In some embodiments the filler is spherical SiO₂ particles. See, for examples, Sato et al., 2017, “Spherical SiO2 Filler for Semiconductor Sealing Materials,” Nippon Steel & Sumitomo Metal Technical Report 117, pp. 44-48, which is hereby incorporated by reference.

Furthermore, in some embodiments, the method 500 includes coupling the filler to the MVQ and/or the urethane acrylate prior to the meltmixing (e.g., block 502 of FIG. 5A).

In some embodiments, the method 500 includes either adding the filler to the solution during the adding step (e.g., block 508 of FIG. 5B) or coupling the filler to the MVQ and/or the urethane acrylate prior to the meltmixing (e.g., block 502 of FIG. 5A), but not both. In alternative embodiments, the method 500 includes either adding the filler to the solution during the adding step (e.g., block 508 of FIG. 5B) or coupling the filler to the MVQ and the urethane acrylate prior to the meltmixing (e.g., block 502 of FIG. 5A).

Blocks 534-536 Referring to block 534, in some embodiments, the filler is carbonaceous, which improves the conductivity of the crosslinked polymer electrode 200. For instance, in some embodiments, the carbonaceous filler includes one or more carbon nanotubes, one or more carbon nanofibers, one or more carbon blacks, graphene, or a combination thereof.

Block 538. Referring to block 538, in some embodiments, the filler includes a metal. For instance, in some such embodiments, the metallic filler provides for improved conductivity for the crosslinked polymer electrode 200. In some embodiments, the metallic filler is utilized as a dopant by forming non-covalent interactions within the crosslinked polymer during synthesis. However, the present disclosure is not limited thereto.

Blocks 540-542. Referring to block 540, in some embodiments, the metal is gold, silver, tungsten, or a combination thereof. In some such embodiments, the metal filler is in the form of one or more gold nanoparticles, gold nanowire, gold flake, one or more silver nanoparticles, silver nanowire, silver flake, or a combination thereof. For instance, in some embodiments, the particles of the metallic filler have a dimension of about 10 μm to 5 μm, about 5 μm to 1 μm, or less than 1 μm.

Block 544. Referring to block 544, in some embodiments, the filler is coupled with the MVQ and/or the urethane acrylate prior to the meltmixing. For instance, in some embodiments, the filler is physically mixed with the MVQ and/or the urethane acrylate before forming the solution. However, the present disclosure is not limited thereto.

Block 546. Referring to block 546, in some embodiments, the filler is covalently bonded with the MVQ and/or the urethane acrylate prior to the meltmixing. For instance, in some embodiments, the filler is dissolved by the solution and covalently bonds with the MVQ and/or the urethane acrylate.

Now that aspects of various methods for synthesizing a crosslinked polymer electrode in accordance with various embodiments has been describes, details regarding a composition of the present disclosure are provided.

In some embodiments, the present disclosure provides a crosslinked polymer composition. In some embodiments, the crosslinked polymer composition has a matrix that includes silicone cross-linkeded with urethane acrylate. In some embodiments, the crosslinked polymer composition includes a filler disposed within the matrix. In some embodiments, the crosslinked polymer composition has a Young's modulus of between 0.5 megapascals (MPa) and 24 GPa. In some embodiments, the crosslinked polymer composition has a tensile strength between 2 megapascals (MPa) and 20 GPa. In some embodiments, the compressibility of the crosslinked polymer composition is between 20% and 90%. In some embodiments, the resistivity of the crosslinked polymer composition is between 0.01 Ohms centimeter (Ω-cm) and 10 Ω-cm. In some embodiments, the Shore A hardness of the crosslinked polymer composition is between 20 and 95.

In some embodiments, the filler is carbonaceous. In some such embodiments, the carbonaceous filler comprises one or more carbon nanotubes, one or more carbon nanofibers, one or more carbon blacks, graphene, or a combination thereof.

In some embodiments, the filler includes a metal. In some such embodiment, the metal is gold, silver, tungsten, or a combination thereof. In some embodiments, the metal filler is in the form of one or more gold nanoparticles, gold nanowire, gold flake, one or more silver nanoparticles, silver nanowire, silver flake, or a combination thereof.

In some embodiments, the crosslinked polymer further includes one or more hydrophilic materials and/or one or more hygroscopic materials.

In some embodiments, the crosslinked polymer further includes one or more foaming agents.

In some embodiments, a surface roughness average (Ra) of a first surface of the crosslinked polymer is between 0.2 Ra and 3 Ra.

In some embodiments, an abrasion resistance maximum loss of the crosslinked polymer is between 0 mg and 65 mg.

In some embodiments, the maximum strain along a first axis of the crosslinked polymer is between 20% and 1,000% elongation.

### Example 1: A Comparison of Crosslinked Polymer Electrodes Against Silicone and Urethane

Referring to FIG. 6, a first crosslinked polymer electrode and a second crosslinked polymer electrode were synthesized according to a method (e.g., method 500 of FIGS. 5A through 5C) and compared against pure silicone and pure urethane acerylate. More specifically, a pure silicone electrode was fabricated by meltmixing the silicone with 4 parts DBPH and 10 part nanocarbon tubes (e.g., NC7000 nanocarbon tubes), and a pure urethane acrelate electrode as fabricated by meltmixing the urethane acrylate with 4 parts DBPH and 10 parts nanocarbon tubes.

The first crosslinked polymer electrode was fabricated by meltmixing the urethane acrylate with 4 parts DBPH, 10 parts nanocarbon tubes, and 10 parts nanocarbon fiber with a 99:1 MVQ: silicone wt %: wt % ratio. The second crosslinked polymer electrode was fabricated by meltmixing the urethane acrylate with 4 parts DBPH, 10 parts nanocarbon tubes, and 10 parts nanocarbon fiber with a 90:1 MVQ: silicone wt %: wt % ratio.

Accordingly, the pure silicone provided a material with low bonding strength that was not suitable for use as a conductive hybrid elastomer.

Moreover, the pure urethane acrylate provided a material that was too rigid and hard, as represented by the excessive hardness.

### EXEMPLARY IMPLEMENTATIONS

Implementation 1. A method of synthesizing a crosslinked polymer electrode, in which the method comprises: meltmixing (i) methylvinyl silicone rubber (MVQ) having a vinyl content of between 0.05 percent and 5 percent and (ii) urethane acrylate at a temperature of between 125° C. and 225° C., in which the MVG to urethane acrylate wt/wt ratio is between 1:10 and 1000:1 at initiation of the meltmixing, thereby forming a solution; and adding a peroxide, at between 0.1 wt % to 5 wt % to the solution, while mixing the solution, thereby forming the crosslinked polymer electrode in which the MVQ is cross-linked with urethane acrylate and in which the crosslinked polymer electrode has a Young's modulus of between 0.5 MPa and 24 GPa (e.g., between 2 MP and 10 MPa).

Implementation 2. The method of Implementation 1, in which the urethane acrylate has an average molecular weight of between 1,000 g/mole and 5,000 g/mole.

Implementation 3. The method of either of Implementation 1 or 2, in which the peroxide is 2,5-di(tertbutylperoxy)-2,5-mercapropinoate (DBPH).

Implementation 4. The method according to any one of Implementations 1-3, in which the MVQ has an average molecular weight of between 300,000 g/mole and 900,000 g/mole.

Implementation 5. The method according to any one of Implementations 1-4, the method further comprising (i) adding a filler to the solution during the adding step, or (ii) coupling the filler to the MVQ and/or the urethane acrylate prior to the meltmixing.

Implementation 6. The method of Implementation 5, in which the filler is carbonaceous.

Implementation 7. The method according to either of Implementation 5 or 6, in which the carbonaceous filler comprises one or more carbon nanotubes, one or more carbon nanofibers, one or more carbon blacks, graphene, or a combination thereof.

Implementation 8. The method according to any one of Implementations 5-7, in which the filler comprises a metal.

Implementation 9. The method of Implementation 8, in which the metal is gold, silver, tungsten, or a combination thereof.

Implementation 10. The method according to either of Implementation 8 or 9, in which the metal filler is in the form of one or more gold nanoparticles, gold nanowire, gold flakes, one or more silver nanoparticles, silver nanowire, silver flakes, or a combination thereof.

Implementation 11. The method according to any one of Implementations 5-10, in which the filler is coupled with the MVQ and/or the urethane acrylate prior to the meltmixing.

Implementation 12. The method according to Implementation 11, in which the filler is covalently bonded with the MVQ and/or the urethane acrylate prior to the meltmixing.

Implementation 13. The method according to any one of Implementations 1-12, the method further comprising adding an additive polymer having a conductance of between 0.001 S/cm and 1,000 S/cm to the solution during the adding step.

Implementation 14. The method according to any one of Implementations 1-13, the method further comprising adding one or more hydrophilic materials and/or one or more hygroscopic materials to the solution during the adding step.

Implementation 15. The method according to any one of Implementations 1-14, the method further comprising adding one or more foaming agents to the solution during the adding step.

Implementation 16. The method according to any one of Implementations 1-15, in which a surface roughness average (Ra) of a first surface of the crosslinked polymer electrode is between 0.2 Ra and 3 Ra.

Implementation 17. The method according to any one of Implementations 1-16, in which a resistivity of the crosslinked polymer electrode is between 0.01 Ohms centimeter (Ω-cm) and 10 Ω-cm.

Implementation 18. The method according to any one of Implementations 1-17, in which a Shore A hardness of the crosslinked polymer electrode is between 20 and 95.

Implementation 19. The method to any one of Implementations 1-18, in which an abrasion resistance maximum loss of the crosslinked polymer electrode is between 0 milligrams (mg) and 65 mg.

Implementation 20. The method according to any one of Implementations 1-19, in which the crosslinked polymer electrode has a tensile strength between 2 MPa and 20 GPa.

Implementation 21. The method according to any one of Implementations 1-20, in which the compressibility of the crosslinked polymer electrode is between 20% and 90%.

Implementation 22. The method according to any one of Implementations 1-21, in which a maximum strain along a first axis of the crosslinked polymer electrode is between 20% and 1,000% elongation.

Implementation 23. An electronic device comprising: a first circuit component; and a crosslinked polymer electrode in electronic communication with the first circuit component, in which the crosslinked polymer electrode comprises methylvinyl silicone rubber (MVQ) cross-linked with urethane acrylate, in which the MVG to urethane acrylate wt/wt ratio is between 1:1 and 1000:1 and in which the Young's modulus of the crosslinked polymer electrode is between 0.5 MPa and 24 GPa.

Implementation 24. The electronic device of Implementation 23, the electronic device further comprising a substrate, in which the crosslinked polymer electrode is disposed as a layer on the substrate and in electrical communication with the first circuit component through the substrate, and in which the substrate comprises a metal material, a plastic material, an elastomer material, or a combination thereof.

Implementation 25. The electronic device of Implementation 24, in which the layer has a thickness between 15 microns (μm) and 5,000 μm.

Implementation 26. The electronic device according to Implementation 23, the electronic device further comprising a substrate, in which the crosslinked polymer electrode comprises one or more folded layers formed on the substrate and in electrical communication with the first circuit component through the substrate, and in which the substrate comprises a metal material, a plastic material, an elastomer material, or a combination thereof.

Implementation 27. The electronic device of Implementation 26, in which the one or more folds comprises one or more alternating folds.

Implementation 28. The electronic device according to any one of Implementations 23-27, in which a surface roughness average (Ra) of a first surface of the crosslinked polymer electrode is between 0.2 Ra and 3 Ra.

Implementation 29. The electronic device according to any one of Implementations 23-28, in which a resistivity of the crosslinked polymer electrode is between 0.01 Ohms centimeter (22-cm) and 10 Ω-cm.

Implementation 30. The electronic device according to any one of Implementations 23-29, in which a Shore A hardness of the crosslinked polymer electrode is between 20 and 95.

Implementation 31. The electronic device according to any one of Implementations 23-30, in which an abrasion resistance maximum loss of the crosslinked polymer electrode is between 0 milligrams (mg) and 65 mg.

Implementation 32. The electronic device according to any one of Implementations 23-31, in which the crosslinked polymer electrode has a tensile strength that is between 2 MPa and 20 GPa.

Implementation 33. The electronic device according to any one of Implementations 23-32, in which a maximum strain along a first axis of the crosslinked polymer electrode is between 20% and 1,000% elongation.

Implementation 34. The electronic device according to any one of Implementations 23-33, in which the compressibility of the crosslinked polymer electrode is between 20% and 90%.

Implementation 35. A crosslinked polymer composition that includes both a matrix including silicone cross-linked with urethane acrylate and a filler that is disposed within the matrix, in which the crosslinked polymer composition includes: (i) a Young's modulus of between 0.5 megapascals (MPa) and 24 GPa; (ii) a tensile strength between 2 megapascals (MPa) and 20 GPa; (iii) compressibility between 20% and 90; (iv) resistivity between 0.01 Ω-cm and 10 Ω-cm; and (v) a Shore A hardness between 20 and 95; or (v) a combination thereof.

### CONCLUSION

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method of synthesizing a crosslinked polymer electrode, the method comprising:
meltmixing (i) methylvinyl silicone rubber (MVQ) having a vinyl content of between 0.05 percent and 5 percent and (ii) urethane acrylate at a temperature of between 125° C. and 225° C., wherein the MVG to urethane acrylate wt/wt ratio is between 1:1 and 1000:1 at initiation of the meltmixing, thereby forming a solution; and
adding a peroxide, at between 0.1 wt % to 5 wt % to the solution, while mixing the solution, thereby forming the crosslinked polymer electrode in which the MVQ is cross-linked with urethane acrylate and wherein the crosslinked polymer electrode has a Young's modulus of between 0.5 MPa and 24 GPa.

2. The method of claim 1, wherein the urethane acrylate has an average molecular weight of between 1,000 g/mole and 5,000 g/mole.

3. The method of claim 1, wherein the peroxide is 2,5-di(tertbutylperoxy)-2,5-mercapropinoate (DBPH).

4. The method of claim 1, wherein the MVQ has an average molecular weight of between 300,000 g/mole and 900,000 g/mole.

5. The method of claim 1, the method further comprising (i) adding a filler to the solution during the adding, or (ii) coupling the filler to the MVQ and/or the urethane acrylate prior to the meltmixing.

6. The method of claim 5, wherein the filler is carbonaceous and comprises one or more carbon nanotubes, one or more carbon nanofibers, one or more carbon blacks, graphene, or a combination thereof.

7. The method of claim 5, wherein the filler comprises a metal.

8. The method of claim 7, wherein the metal is gold, silver, tungsten, or a combination thereof.

9. The method of claim 7, wherein the metal is in the form of one or more gold nanoparticles, gold nanowire, gold flake, one or more silver nanoparticles, silver nanowire, silver flake, or a combination thereof.

10. The method of claim 5, wherein the filler is coupled with the MVQ and/or the urethane acrylate prior to the meltmixing.

11. The method of claim 5, wherein the filler is covalently bonded with the MVQ and/or the urethane acrylate prior to the meltmixing.

12. The method of claim 1, the method further comprising adding an additive polymer having a conductance of between 0.001 Siemens per centimeter (S/cm) and 1,000 S/cm to the solution during the adding step.

13. The method of claim 1, the method further comprising introducing, during the adding, (i) one or more hydrophilic materials and/or one or more hygroscopic materials to the solution and/or (ii) one or more foaming agents to the solution.

14. The method of claim 1, wherein a surface roughness average (Ra) of a first surface of the crosslinked polymer electrode is between 0.2 Ra and 3 Ra.

15. The method of claim 1, wherein a resistivity of the crosslinked polymer electrode is between 0.01 Ohms centimeter (Ω-cm) and 10 Ω-cm.

16. The method of claim 1, wherein a Shore A hardness of the crosslinked polymer electrode is between 20 and 95.

17. The method of claim 1, wherein an abrasion resistance maximum loss of the crosslinked polymer electrode is between 0 milligrams (mg) and 65 mg.

18. The method of claim 1, wherein the crosslinked polymer electrode has a tensile strength between 2 MPa and 20 GPa.

19. The method of claim 1, wherein the compressibility of the crosslinked polymer electrode is between 20% and 90%.

20. The method of claim 1, wherein the maximum strain along a first axis of the crosslinked polymer electrode is between 20% and 1,000% elongation.
